(19) United States
(12) Patent Application Publication
(10) Pub. No.: US 2010/0250898 A1
(43) Pub. Date: Sep. 30, 2010

(54) PROCESSING ELEMENT AND DISTRIBUTED PROCESSING UNIT

(75) Inventors: Takayuki NAKATOMI, Tokyo (JP); Mitsunori Kubo, Hachioji-shi (JP); Arata Shinozaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/728,592

(22) Filed: Mar. 22, 2010

(30) Foreign Application Priority Data
Mar. 24, 2009 (JP) 2009-072393

(51) Int. Cl. G06F 15/76; G06F 9/02

(52) U.S. Cl. 712/30; 712/37; 712/E09.002

(57) ABSTRACT

A general-purpose processing element has a program holding portion that can hold a program by which a specific function is implemented in the general-purpose processing element. A distributed processing system according to the invention includes a control unit, a plurality of processing elements connected to the control unit, and a client, wherein the plurality of processing elements include the above-described processing element.

### CROSS-REFERENCE TO RELATED APPLICATION

The present application is based upon and claims the benefit of priority from the prior Japanese Patent Application No. 2009-072393 filed on Mar. 24, 2009; the entire contents of which are incorporated herein by reference.

### BACKGROUND OF THE INVENTION

1. Field of the Invention

The present invention relates to a processing element.

2. Description of the Related Art

In conventional client-server systems, a program to be used has been installed in a server in advance. A client may communicate with the server to cause the server to perform a specific processing. For example, in the case of calculation using the finite element method, a calculating program is installed in the server in advance. Then, data is sent from the client to the server, where data is subject to calculation. Lastly, the result is returned from the server to the client. This type of system has been disclosed, for example, in Japanese Patent Application Laid-Open No. 2001-337816.

### SUMMARY OF THE INVENTION

A processing element according to the present invention is a general-purpose processing element that has a program holding portion that can hold a program by which a specific function is implemented in the general-purpose processing element.

A distributed processing system according to a second aspect of the invention includes a control unit, a plurality of processing elements connected to the control unit, and a client, wherein the plurality of processing elements include the above-described processing element.

A processing element according to a third aspect of the present invention comprises a single machine, and a plurality of general-purpose processing elements operating on the single machine, wherein the general-purpose processing elements include the general-purpose processing element

### BRIEF DESCRIPTION OF THE DRAWINGS

FIG. 1 is a diagram showing the basic configuration of a general-purpose processing element according to the present invention.

FIG. 2 is another diagram showing the basic configuration of the general-purpose processing element according to the present invention.

FIG. 3 is a diagram showing a procedure of registering general-purpose processing elements to a control unit. FIG. 4 is a diagram showing the data structure of communication data.

FIG. 5 is a flow chart of a process of loading a dynamic processing library from a control unit into a general-purpose processing element.

FIG. 6 is a sequence diagram showing a procedure of loading a dynamic processing library from the control unit into a general-purpose processing element.

FIG. 7 is a flow chart showing a process of loading a dynamic processing library into a general-purpose processing element.

FIG. 8 is a flow chart showing a process in a load determination section of a general-purpose processing element with variable slot number.

FIG. 9 is a sequence diagram showing a procedure of transmitting a dynamic processing library from the control unit to a general-purpose processing element.

FIG. 10 is a sequence diagram showing a procedure of loading a dynamic processing library from a DPL repository into a general-purpose processing element in response to a request made by the client.

FIG. 11 is a flow chart showing a process of task execution.

FIG. 12 is a sequence diagram showing a procedure of task execution.

FIG. 13 is a sequence diagram showing a procedure followed in the case where unloading of a dynamic processing library is requested by a client.

FIG. 14 is a flow chart showing a process of unloading a dynamic processing library with designation of a task identifier, executed by a general-purpose processing element.

FIG. 15 is a flow chart showing a process of removing the dynamic processing library with designation of task identifier, executed by a general-purpose processing element.

FIG. 16 is a sequence diagram showing a procedure of unloading request made to a general-purpose processing element by the control unit.

FIG. 17 is a flow chart showing a procedure of unloading process in the general-purpose processing element in response to a request made by the control unit.

FIG. 18 is a flow chart showing a process of selecting a dynamic processing library to be removed from a magazine without designation of a task identifier.

FIG. 19 is a flow chart showing a process of selecting a dynamic processing library to be unloaded from a slot without designation of task identifier.

FIG. 20 is a sequence diagram showing a procedure of reloading a dynamic processing library into the general-purpose processing element in accordance with a request made by the control unit.

FIG. 21 is a flow chart showing a process of reloading the dynamic processing library.

FIG. 22 is a flow chart showing a process executed by a general-purpose processing element to unload a dynamic processing library.

FIG. 23 is a sequence diagram showing a procedure of loading a dynamic processing library from the control unit into a general-purpose processing element and executing a process.

FIG. 24 is a sequence diagram showing a procedure of loading a dynamic processing library from a DPL repository into a general-purpose processing element and executing a process.

FIG. 25 is a flow chart showing a process of JPEG encoding.

FIG. 26 is a sequence diagram showing a procedure of registering processing elements to the control unit.

FIG. 27 is a sequence diagram showing a procedure of loading a dynamic processing library for DCT from a client.

FIG. 28 is a sequence diagram showing a procedure of executing JPEG encoding in accordance with a request made by a client,

FIG. 29 is a sequence diagram showing a procedure of DCT using a general-purpose processing element.

FIG. 30 is a sequence diagram in the case where an error that a task cannot be executed at the time when a service execution request is made occurs.

FIG. 31 is a sequence diagram showing a procedure of loading a dynamic processing library in the case where a service is lacking upon executing JPEG encoding.

FIG. 32 is a sequence diagram showing a process of JPEG encoding requested by the client.

FIG. 33 is a sequence diagram showing a process in which general-purpose processing elements are used for color signal conversion and DCT.

FIG. 34 is a sequence diagram showing a procedure in which a dynamic processing library for DOT is transmitted from a client, an existing dynamic processing library is unloaded from a general-purpose processing element, and the dynamic processing library for DCT is loaded into the general-purpose processing element.

FIG. 35 is a sequence diagram in the case where an error that there is no empty slot when loading of a dynamic processing library is attempted occurs.

FIG. 36 is a sequence diagram showing a procedure of registering a processing element.

FIG. 37 is a sequence diagram showing a process of JPEG encoding in which two general-purpose processing elements operate on a single machine.

### DETAILED DESCRIPTION OF THE INVENTION

In the following, embodiments of the processing element according to the present invention will be described in detail with reference to the accompanying drawings. It should be understood that the present invention is not limited to the embodiments.

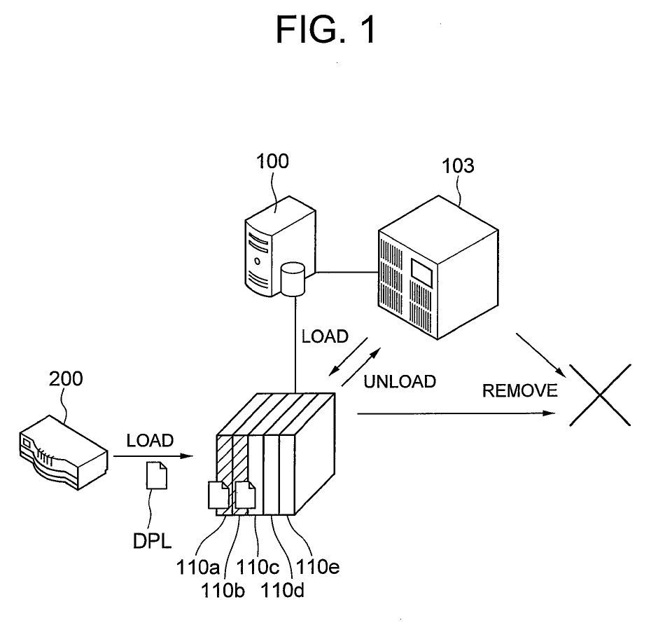

FIG. 1 shows the basic configuration of the processing element according to the present invention.

A general-purpose processing element 100 has a plurality of slots 110a, 110b, 110c, 110d, 110e. The slots 110a to 110e correspond to program storing portion.

The general-purpose processing element 100 has a magazine 103 that will be described later. The general-purpose processing element 100 is connected with a control unit 200.

The general-purpose processing element 100 is, for example, a general-purpose CPU. The general-purpose processing element 100 fitly is loaded with a program suitable for the type of the processing element as needed. This program will be referred to as a dynamic processing library DPL. With this program, the processing element 100 can execute a specific task.

Here, terms used in the following description will be described in advance.

### <Client>

The term “client” refers to a terminal device used by a user. The client sends instructions to a control unit and a processing element.

### <Control Unit>

The term “control unit” refers to a control section that performs management of information on the processing element, makes a determination as to which processing element is to be used in response to a request from a user, performs management of processing paths, and performs management of transition of task execution during the execution of a service.

### <Special-Purpose Processing Element>

The term “special-purpose processing element” refers to a node used in computation. The special-purpose processing element provides a specific process or a task that will be described later. The special-purpose processing element has the function of processing or executing one or more tasks, the function of inputting/outputting data needed in the task processing, and the function of storing data.

### <General-Purpose Processing Element>

The term “general-purpose processing element” refers to a node used in computation. The general-purpose processing element can perform an arbitrary task processing using a dynamic processing library described below.

### <Dynamic Processing Library>

The term “dynamic processing library” refers to a file (or program) to be loaded into a general-purpose processing element to enable task execution. The dynamic processing library will sometimes be referred to as “DPL” hereinafter.

### <Task>

The term “task” refers to a specific process provided by a processing element. For example, a JPEG encoding process may comprise a plurality of divisional processing blocks such as a downsampling block and a DCT block. Each processing block (e.g. “downsampling”) among these processing blocks is a task. Each task is provided with an identification number called a task identifier (TID). In the context of this specification, it is assumed that widely used tasks are provided beforehand with task identifiers, which are known to everyone.

### <Service>

The term “service” refers to a set of one or more related tasks. The service provides a process having a more organized purpose than the task. For example, a JPEG encoding process is an example of the service. Each service is also provided with a unique identification number called a service identifier (SID).

### <Loading>

The term “loading (or load)” refers to an operation by which the dynamic processing library DPL is stored in a slot of a general-purpose processing element, the validity of the dynamic processing library DPL is verified by the general-purpose processing element, and the dynamic processing library DPL is made usable.

### <Slot>

The term “slot” refers to a portion (e.g. a space in a memory or storage device) provided in the general-purpose processing element in which an executable dynamic processing library DPL is stored. The general-purpose processing element has at least one slot. The slot corresponds to the program storing portion.

### <Magazine>

The term “magazine” refers to a portion provided in the general-purpose processing element in which a dynamic processing library DPL that cannot be stored in the slot is saved. Some general-purpose processing elements have no magazine.

### <Unloading>

The term “unloading (or unload)” refers to an operation by which a dynamic processing library DPL is taken away from a slot of a general-purpose processing element, whereby the service provided by the dynamic processing library DPL is made unavailable. The unloaded dynamic processing library DPL is moved to the magazine or “removed” in the sense defined immediately below.

### <Removing>

The term “removing” refers to an operation by which a dynamic processing library DPL is deleted from the general-purpose processing element. The dynamic processing library DPL that has been removed is unavailable unless it is loaded again.

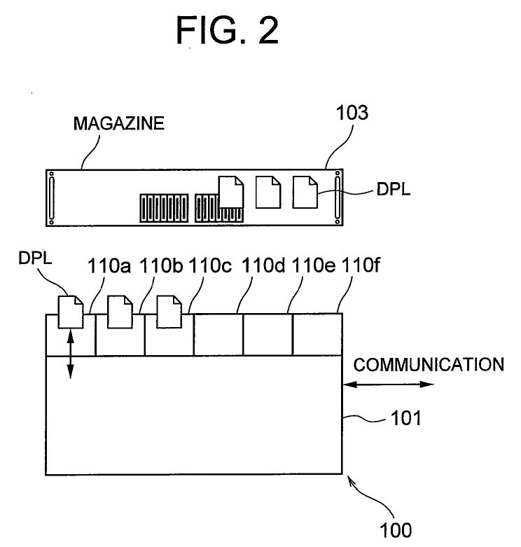

FIG. 2 shows the basic configuration of the general-purpose processing element 100. The general-purpose processing element 100 can implement the function of a dynamic processing library DPL. The general-purpose processing element 100 has a control section 101. The control section 101 may be either hardware or software.

For example, a general-purpose processing element program serving as the control section is software running on an OS of a computer. The general-purpose processing element program is adapted to communicate with the special-purpose processing element, the general-purpose processing element, and the control unit, send data to be processed to the dynamic processing library DPL, and receive and send the result of processing. In the context of this specification, the term “general-purpose processing element” refers to a general-purpose processing element program.

Next, the functions of the general-purpose processing element will be described. The general-purpose processing element has the following functions:
(1) the function of loading a dynamic processing library DPL;
(2) the function of providing the task of the loaded dynamic processing library DPL, namely the function of operating as a processing element that provides the loaded task;
(3) the function of caching the dynamic processing library DPL;
(4) the function of unloading the dynamic processing library DPL; and
(5) the function of removing the dynamic processing library DPL.

In the following, the above-mentioned functions will be described.

When the function of loading a dynamic processing library DPL is performed, the general-purpose processing element is controlled by the control unit at first. In order to enable loading of a suitable dynamic processing library DPL into the general-purpose processing element, the following items of information are registered in the control unit upon the registration of the general-purpose processing element to the control unit: the operating system (OS) that the general-purpose processing element supports; the CPU architecture that the general-purpose processing element supports; the number of empty slots; and the listening TCP port number.

Examples of the OS include 32-bit Windows (Registered Trademark), 64-bit Windows, and Linux. Examples of the CPU include Intel Pentium (Registered Trademark) x86 and Intel Core 2 Duo 64 bit. In any case, numerical values associated with the respective OSs and CPUs are defined beforehand. These numerical values are used to determine which dynamic processing library DPL can be loaded into which general-purpose processing element.

The term “the number of empty slots” refers to a value indicating the number of dynamic processing libraries DPL that can be loaded into the general-purpose processing element. When one dynamic processing library DPL can be loaded at one time, the number of empty slots is one. When five dynamic processing libraries DPL can be loaded, the number of empty slots is five.

The configurations of the slots are categorized into two different types in terms of the number of slots. In one type, the number of slots that can hold a dynamic processing library DPL is determined statically, or the maximum number of slots is fixed. In the other type, the number of slots increases and decreases dynamically.

In the case of a general-purpose processing element having the dynamically determined number of slots, the value “−1” is sent as the information on the number of empty slots at the time of the registration on the control unit. The processing element in which the number of slots is statically determined will be referred to as the general-purpose processing element with fixed slot number. The processing element in which the number of slots dynamically increases and decreases will be referred to as the general-purpose processing element with variable slot number.

The value of the number of empty slots recorded in the control unit and the general-purpose processing element is decreased by 1 when a dynamic processing library DPL is loaded into the general-purpose processing element by the control unit, and increased by 1 when a dynamic processing library DPL is unloaded. The procedure by which the control unit recognizes the unloading of the dynamic processing library DPL from the general-purpose processing element will be described later.

A dynamic processing library DPL can be loaded only into an empty slot. Consequently, a dynamic processing library DPL cannot be loaded into a general-purpose processing element in which the number of empty slots is zero.

Furthermore, a process by which the dynamic processing library DPL is moved from a magazine 103 provided on the general-purpose processing element into a slot 110a etc. will also be referred to as “loading”.

The listening TCP port number is the port number of the TCP port that is waiting for connection to the general-purpose processing element from others. Here, for the convenience of description, communication using TCP/IP will be described, but the type of communication is not limited to this. The control unit can get the IP address of the general-purpose processing element at the time of the first connection from the general-purpose processing element to the control unit. Therefore, the IP address is not included in the registration information.

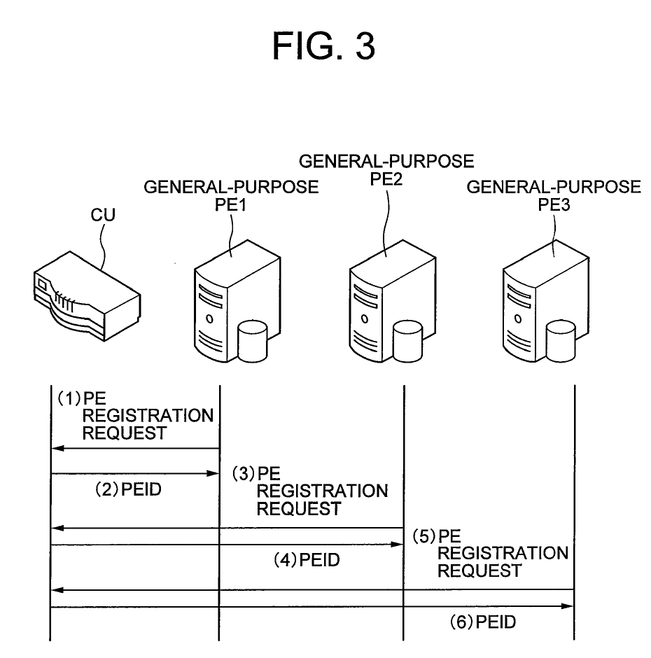

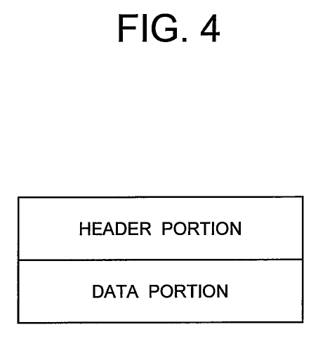

FIG. 3 shows the procedure of registration of general-purpose processing elements PE1, PE2, and PE3 to the control unit CU. In the flows indicated by solid arrows in FIG. 3, the communication is performed using the data structure shown in FIG. 4. The data structure includes a header and a data The header contains information indicating the content of a request etc. The content of the data depends on the content of the header.

In FIG. 3, first in step (1) of the sequence, the general-purpose processing element PE1 sends a PE registration request to the control unit CU. The content of the data sent hereby is presented in Table 1.

TABLE 1

| Information | Description |
|---|---|
| CPU | CPU type of PE |
| OS | OS type of PE |
| TID | task identifier(s) provided by the PE; “999” |
| | in the case of a general-purpose processing |
| | element |
| Number of | “0” in the case of the special-purpose PE; |
| empty slots | the fixed number of empty slots in the case |
| | of a general-purpose processing element |
| | with statically determined number of empty |
| | slots; |
| | −1 in the case of a general-purpose |
| | processing element with dynamically |
| | variable number of empty slots |
| Listening port | the TCP port number used by general-purpose |
| number | processing element |

The general-purpose processing element and the special-purpose processing element send the same type of information. The control unit CU determines whether the processing element that has sent the information is a general-purpose processing element or a special-purpose processing element based on the TIC sent by the processing element.

In step (2) of the sequence, the control unit CU registers the general-purpose processing elements PE1 to PE3 in a PE management table in the control unit CU has. The control unit CU issues a processing element identifier that is unique in the control unit CU, and sends a response having the content presented in Table 2.

TABLE 2

| Information | Description |
|---|---|
| PEID | PE identifier |

The PE management table in the control unit CU holds information on the special-purpose processing element and the general-purpose processing element that are registered in the control unit CU. Table 3 shows the content of the information held in the PE management table and Table 4 shows a specific example of the content of the information. In steps (3), (4), (5), and (6) of the sequence, the other general-purpose processing elements PE2 and PE3 execute the same process described above. Here, the order of the registration of the processing elements to the control unit CU does not matter.

Table 3 shows the management table in the control unit CU.

TABLE 3

| Information | Description |
|---|---|
| PE address | IP address of PE |
| PEID | ID of PE |
| CPU | CPU type of PE |
| OS | OS type of PE |
| TID | TID executable by PE |
| Number of empty slots | the number of empty slots at present |
| Listening port number | listening port number of PE |

TABLE 4

| Information | PE1 | PE2 | PE3 |
|---|---|---|---|
| PE address | 192.168.0. | 192.168.0. | 192.168.0. |
| (Port Number) | 101:1234 | 102:1234 | 103:1234 |
| PEID | 1 | 2 | 3 |
| CPU | company A | company B | company C |
| OS | X | Y | Z |
| TID | 999 | 999 | 999 |
| Number of | 5 | 1 | −1 |
| empty slots | | | |

Then, the dynamic processing library DPL is transmitted from the control unit CU to the general-purpose processing elements PE1 to PE3. Here, it is assumed that the control unit CU already has the dynamic processing library DPL and information on it.

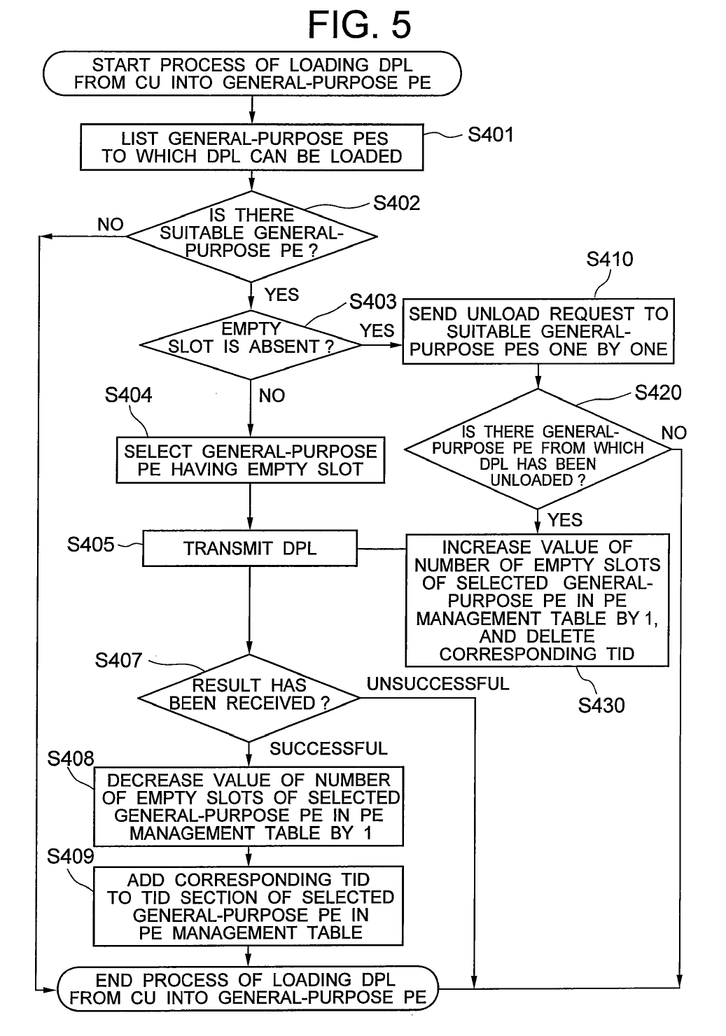

FIG. 5 is a flow chart showing the process of loading the dynamic processing library DPL into the general-purpose processing elements PE1, PE2 and PE3.

In step S401, the control unit CU searches for general-purpose processing elements into which the dynamic processing library DPL can be loaded with reference to the PE management table.

If a plurality of general-purpose processing elements are found in step 5402, the first found general-purpose processing element that has an empty slot is selected. If no general-purpose processing element is found in step S402, the loading process is terminated.

If the determination in step S402 is affirmative, a determination is made, in step S403, as to whether or not an empty slot is absent, with respect to all the general-purpose processing elements to which the dynamic processing library DPL can be loaded. If there is no general-purpose processing element having an empty slot, an unload request is sent, in step S410, to the general-purpose processing elements in sequence in order from the first general-purpose processing element PE1. The content of the unload request is presented in Table 5. The information sent to the control unit by return upon completion of unloading is presented in Table 6. Details of the unloading process will be described later.

TABLE 5

| Information | Description |
|---|---|
| TID | task identifier |

TABLE 6

| Information | Description |
|---|---|
| PEID | PE identifier |
| TID | task identifier |

In step S420, a determination is made as to whether or not there is a general-purpose processing element from which a dynamic processing library DPL has been unloaded. If there is a general-purpose processing element from which a dynamic processing library DPL has been unloaded, the value of the number of empty slots of that general-purpose processing element in the PE management table is increased by 1, and the task identifier TID is deleted. Then the process proceeds to step S405 or a DPL transmission step.

If there is no general-purpose processing element from which a dynamic processing library DPL has been unloaded, the process is terminated.

In the above process, there may be cases in which after the unload request has been made, another dynamic processing library DPL (or a dynamic processing library DPL other than that for which unloading is requested) that has been loaded in the general-purpose processing element is removed, and the control unit CU is notified of the removal. There may also be cases in which no dynamic processing library DPL is unloaded. If this is the case, the process is terminated, because the dynamic processing library DPL cannot be loaded additionally.

If the determination in step S403 is negative, a general-purpose processing element to which the dynamic processing library DPL can be loaded is selected, in step S404. In step S405, the dynamic processing library DPL is transmitted to the selected general-purpose processing element. The content of information transmitted at this time is presented in Table 7.

TABLE 7

| Information | Description |
|---|---|
| TID | task identifier |
| DPL | DPL file |

In step S407, a determination is made as to whether the control unit CU has received the result information or not. An error may occur in the case of the general-purpose processing element having slots of which the number has not been determined in advance, namely the general-purpose processing element with dynamically variable number of slots, depending on the state of the general-purpose processing element at the time. If the control unit CU fails to receive the result information, the loading process is terminated.

If the receipt of the result information is successful in step S407, the value of the number of empty slots in the PE management table is decreased by 1, in step S408. In the case of the general-purpose processing element with dynamically variable number of slots, no change is made to the value of the number of empty slots in this step.

In step S409, the TID of the dynamic processing library DPL thus loaded is added to the TID section of the PE management table, and the process is terminated.

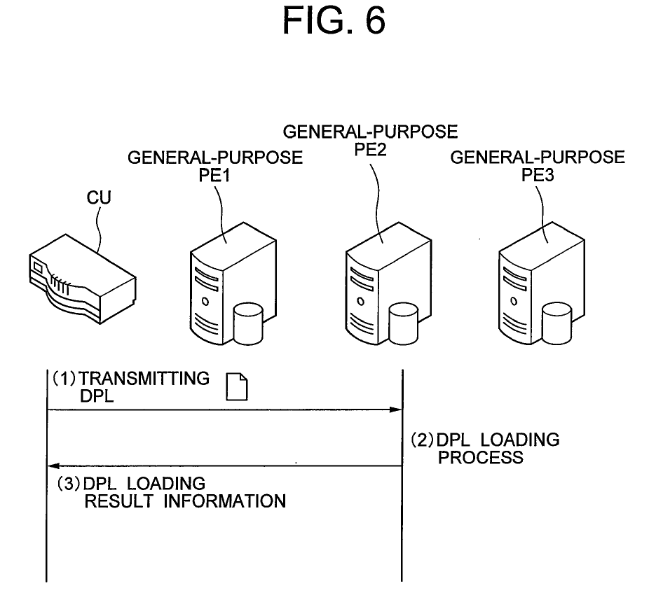

FIG. 6 is a sequence diagram showing the process of loading the dynamic processing library DPL. FIG. 6 shows a sequence in the case where the control unit CU transmits a dynamic processing library DPL that can run on a CPU manufactured by Company B and an OS “Y” to the general-purpose processing element PE2.

The control unit CU recognizes, with the above-described algorithm, that a general-purpose processing element to which the dynamic processing library DPL can be loaded is the general-purpose processing element PE2.

(1) Since the general-purpose processing element PE2 has an empty slot(s), the control unit CU transmits the dynamic processing library DPL to the general-purpose processing element PE2.

(2) Upon receiving the dynamic processing library DPL, the general-purpose processing element PE2 checks the dynamic processing library DPL and loads it into a slot (e.g. slot 110a shown in FIG. 1).

(3) The general-purpose processing element PE2 sends the result information to the control unit CU.

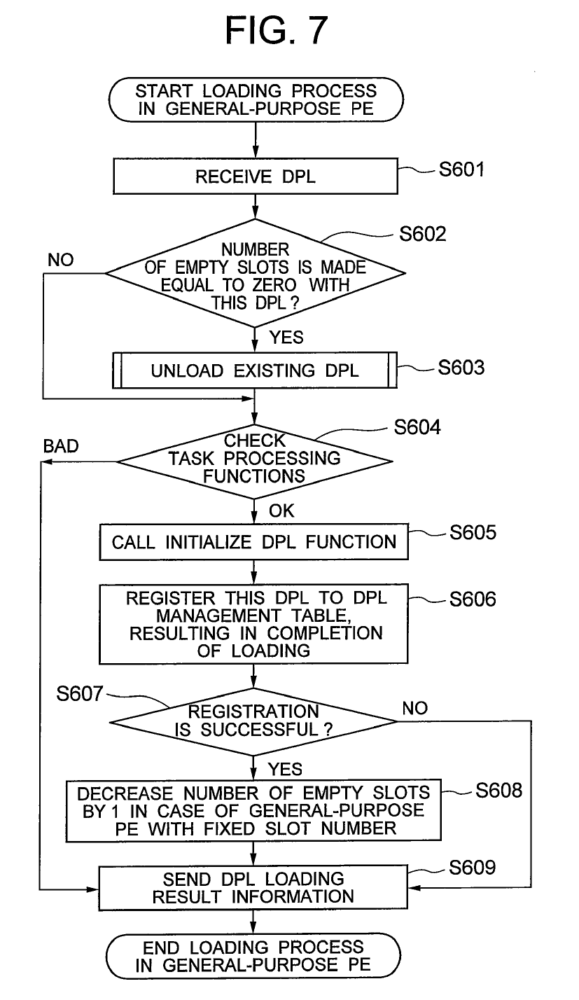

Next, the above-described process of loading the dynamic processing library DPL executed by the general-purpose processing element PE2 will be described with reference to the flow chart shown in FIG. 7.

In step S601, the general-purpose processing element PE2 receives the dynamic processing library DPL.

In step S602, a determination is made as to whether or not the loading of the received dynamic processing library DPL will make the number of the empty slots equal to zero.

If the number of the empty slots will be made equal to zero, a dynamic processing library DPL (if any) that has already been loaded and may be unloaded is unloaded in step S603. This process will be discussed in the later description of the unloading.

If it is determined in step S602 that the number of the empty slots will not be made equal to zero, the process proceeds to step S604.

In step S604, a determination is made as to whether or not the functions needed to execute a task implemented in the dynamic processing library DPL are available. If the determination in step S604 is negative, the process proceeds to step S609, where an error notification is made. Details of the function of the dynamic processing library DPL will be discussed in the later description of the function providing the task of the loaded dynamic processing library DPL.

If the determination in step S604 is affirmative, the initialization function of the dynamic processing library DPL is called, in step S605. Instep S606, the information on this dynamic processing library DPL is registered in a DPL management table of the general-purpose processing element PE2. The loading process is completed with completion of the registration.

The information registered in the DPL management table of the general-purpose processing element is presented in Table 8.

TABLE 8

| Information | Description |
|---|---|
| TID | task identifier |
| number of tasks in execution | number of tasks currently in |
| | execution |
| load time | time when DPL was loaded |
| last used time | time when DPL was used last time |
| storage location | location where DPL is stored |
| | (i.e. in slot or magazine) |

In step S607, a determination is made as to whether or not the registration in the DPL management table is successful. If the registration is unsuccessful, the process proceeds to step S609, and the loading process is terminated.

If the determination in step S607 is affirmative (Yes) the value of the number of empty slots is decreased by 1 (in the case of a general-purpose processing element with fixed slot number), in step S608. In step S609, the load result information is sent to the control unit CU.

In the case of the general-purpose processing element with variable slot number, the number of slots is not determined in advance. This does not means, however, that the number of the loadable dynamic processing libraries DPL is unlimited.

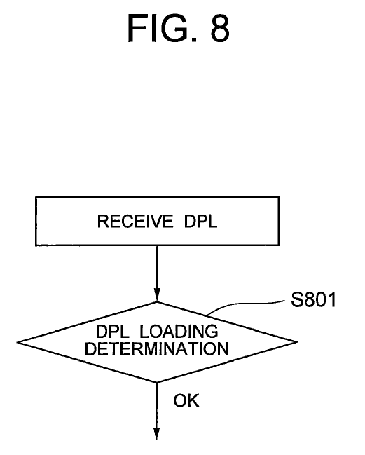

Therefore, step S801 shown in FIG. 8 may be provided to determine that an error occurs upon loading, if, for example, the number of the tasks in execution at the time is larger than a certain number, or the CPU load is high.

Next, the process of loading a dynamic processing library DPL from a client CL into a general-purpose processing element will be described. It is assumed that the client CL already knows the IP address of the control unit CU.

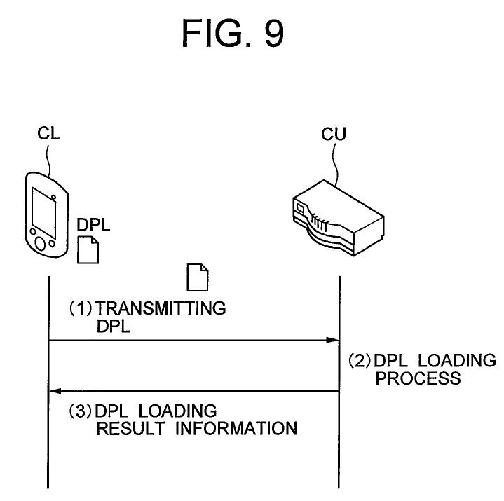

First, as shown in FIG. 9, the client CL transmits the dynamic processing library DPL to the control unit CU. The information sent at the same time is presented in Table 9.

TABLE 9

| Information | Description |
|---|---|
| TID | task identifier |
| CPU | the CPU type on which DPL is |
| | operable |
| OS | OS type on which DPL is operable |
| DPL | Content of DPL file |

In FIG. 9, (1) the control unit CU loads the dynamic processing library DPL into the general-purpose processing element; (2) the loading process is performed in accordance with the above described procedures; and (3) The control unit CU sends the load result information to the client CL.

The dynamic processing library DPL can also be loaded into the general-purpose processing element from a DPL repository in which various dynamic processing libraries DPL are stored. In the DPL repository, sets of the content presented in Table 9 and a dynamic processing library DPL are registered. By externally designating a task identifier TID, the dynamic processing library DPL that provides the designated task can be obtained.

The client CL can designate a task identifier TID. If the DPL repository contains the designated task identifier TID, the DPL is loaded into the general-purpose processing element from the dynamic processing library DPL repository.

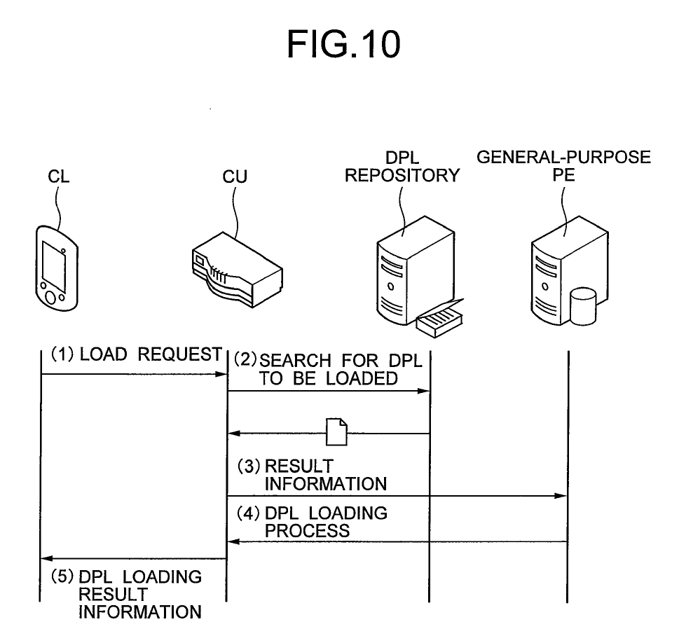

Next, the process in which the control unit CU obtains, in accordance with an instruction from the client CL, the dynamic processing library DPL from the DPL repository and loads it into the general-purpose processing element PE will be described with reference to FIG. 10. It is assumed that the control unit CU has already obtained the information on the DPL repository beforehand.

(1) The client CL sends the task identifier TID of the dynamic processing library DPL to be loaded, as a load request, to the control unit CU.

(2) The control unit CU sends the task identifier TID to the DPL repository to inquire whether or not the dynamic processing library DPL to be loaded is stored in the DPL repository.

(3) The DPL repository makes a search for the requested dynamic processing library DPL in it, and sends the result of search to the control unit CU.

(4) In the case where the requested dynamic processing library DPL is found, the DPL repository transmits the dynamic processing library DPL to the control unit CU together with the result information.

(4) Upon obtaining the dynamic processing library DPL, the control unit CU executes the process of loading the dynamic processing library DPL into the general-purpose processing element PE.

(5) The control unit CU sends the result information indicating whether or not the loading of the dynamic processing library DPL has been successfully done, to the client CL.

Next, the function of caching the dynamic processing library DPL will be described.

The dynamic processing library DPL loaded in the general purpose processing element PE is not deleted from it immediately after the completion of use by a user. The dynamic processing library DPL is held in the general-purpose processing element PE because it may be used again a short time later. The function by which the dynamic processing library DPL is held in the general-purpose processing element PE is referred to as the cache function.

The cached dynamic processing library DPL may either continue to be held in the slot (e.g. slot 110a) or be moved to the magazine 103 from the slot (e.g. slot 110a)

In the case where the dynamic processing library DPL continues to be held in the slot (e.g. slot 110a), the dynamic processing library DPL is stored in the storage portion for storing a dynamic processing library(ies) DPL (or a program(s)).

The term “magazine” comes from the name of a component of a tape device used for data backup, in which tapes are stored. In the analogy with the tape device, the slot corresponds to the drive. For example, the dynamic processing library DPL that is not frequently used is moved to the magazine 103 and stored therein. The dynamic processing library DPL stored in the magazine 103 cannot be executed.

When the dynamic processing library DPL is present in the slot (e.g. 110a) or the magazine 103, the next user of the specific dynamic processing library DPL that has once become out of use may be able to use it without loading it again from the control unit CU. The dynamic processing library DPL can be used only when it is present in a slot. The number of the slots of each general-purpose processing element is determined in accordance with its ability.

At the time of startup of the general-purpose processing element PE, the number of empty slots thereof is notified to the control unit CU. No dynamic processing library DPL has been loaded yet at the time of startup. Therefore, the maximum number of dynamic processing libraries DPL that can be used at a time is equal to the number of empty slots at the time of startup.

When the number of the loaded dynamic processing libraries DPL reaches the maximum number of slots, a dynamic processing library DPL is unloaded in accordance with a predetermined algorithm. Details of the unloading process will be discussed in the later description of the function of unloading the dynamic processing library DPL.

Next, the function of providing the task of the loaded dynamic processing library DPL will be described.

The dynamic processing library DPL needs to have only the core part of the function that implements the task. The general-purpose processing element takes charge of the communication function.

The dynamic processing library DPL has the functions listed in Table 10 as the interface with the general-purpose processing element.

TABLE 10

| | | time when function |
|---|---|---|
| function | operation | is called |
| DPL initialization | initialize DPL | immediately after |
| | | loading DPL |
| DPL deallocation | perform processing | immediately before |
| | for terminating DPL | unloading DPL |
| task starting | perform processing | at the time of |
| | necessary at the | starting the task |
| | time of starting the | |
| | task | |
| task termination | perform | at the time of |
| | post-processing | terminating the |
| | such as | task |
| | deallocation of | |
| | memory at the time | |
| | of terminating the | |
| | task | |
| task execution | receive input data | after receiving |
| | from the | data to be processed |
| | general-purpose | |
| | processing element, | |
| | execute the task | |
| | provided by the DPL, | |
| | and return the | |
| | result information | |
| data deallocation | deallocate memory | at the time when the |
| | allocated in the DPL | memory area becomes |
| | | unnecessary |
| internal parameter | set an internal | at the time when a |
| setting | parameter that | parameter is |
| | determines the | received |
| | operation of the DPL | |

When a new function is added to a program, a block that implements the new function is usually added to the already-existing source code of the program, and processings such as compiling and linking are applied thereto. The new function is provided by replacing the old program file with the new program file and re-executing the program.

On the other hand, there is a method of adding a new function to an existing program without changing it by adding a component called plug-in or add-on. In this method, a protocol for communication between the program and the plug-in is established in advance, and the plug-in is developed in accordance with the protocol. In this way, a new function may be added to an existing program without any change to the program. This invention also relates to the plug-in.

Methods for implementing a plug-in include a dynamic link library in the case of Windows (registered trademark) and a shared library in the case of Linux (which will be simply referred to as library, hereinafter). The library is a file with an extension of “dll” in the case of Windows (registered trademark) and a file with an extension of “.so” in Linux. The library file has a function(s) defined therein.

The program can load such library(ies) after start-up and call the functions in them. To enable calling of functions, it is necessary that the types of the functions to be provided be determined in advance between the program and the libraries. The functions listed in the above Table 10 are such functions. With the provision of the above-described functions, the dynamic processing library DPL can be used by the general-purpose processing element.

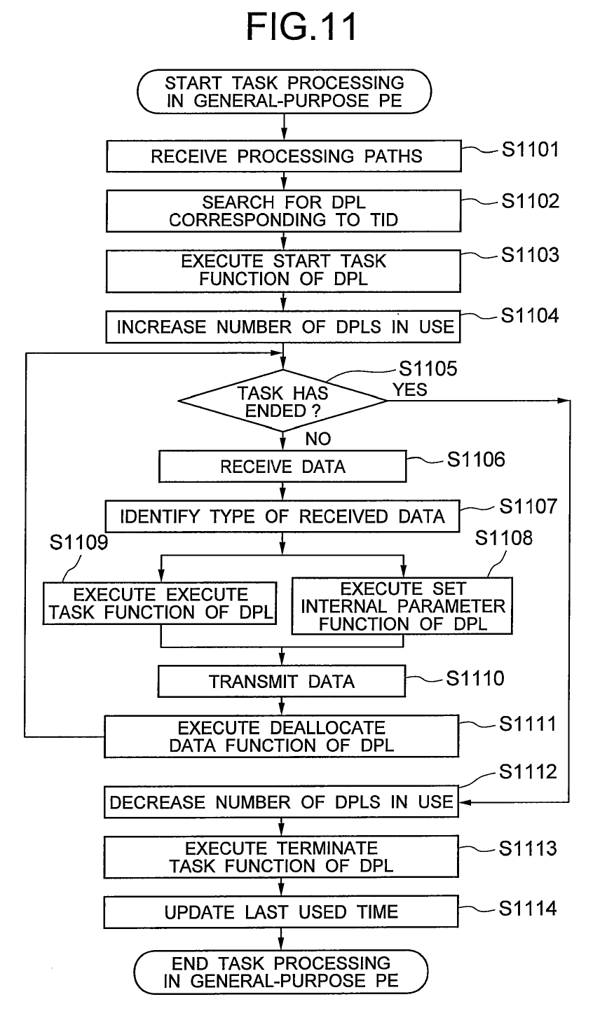

FIG. 11 is a flow chart of the task execution by the general-purpose processing element. In step S1101, the general-purpose processing element receives information on processing paths. The information on processing paths includes the PE address of the input source processing element PE, the PE address of the output destination processing element PE, and the task identifier of the task to be provided by the processing element PE that receives the information.

In step S1102, the dynamic processing library DPL corresponding to the task identifier TID is searched for in the DPL management table.

In step S1103, the task starting function of the dynamic processing library DPL is called. In step S1104, the value of the number of dynamic processing libraries DPL in use is increased by 1.

In step S1104, data reception is continued until the task ends after step 1104 is completed.

In step S1105, a determination is made as to whether or not the task has ended. If the task has not ended, the general-purpose processing element PE continues the data reception, in step S1106. In step S1107, the type of the received data is identified.

In accordance with the result of the identification in step S1107, the process proceeds to either step S1109 or step S1108. In step S1109, the task execution function is called. In step S1108, the internal parameter setting function is called.

In step S1110, the general-purpose processing element PE transmits the processing result data to the subsequent processing element. In step S1111, the data deallocation function of the dynamic processing library DPL is executed.

If the determination in step S1105 is affirmative (YES), namely if the task has ended, the value of the number of dynamic processing libraries DPL in use is decreased by 1 in step S1112. In step S1113, the task termination function is called. In step S1114, the last used time in the DPL management table is updated.

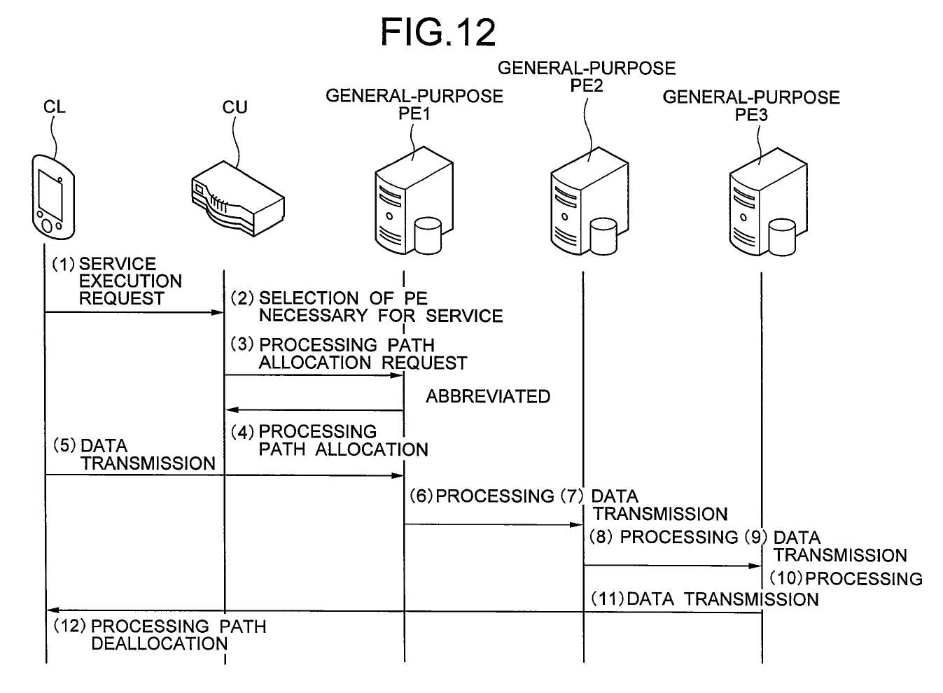

Next, the procedure of service execution will be described with reference to FIG. 12. Here, it is assumed that the dynamic processing library DPL that provides the task necessary for the service has already been loaded into the general-purpose processing element PE.

(1) First, the client CL sends a service execution request to the control unit CU.

(2) The control unit CU selects processing elements PE necessary for the requested service.

(3) The control unit CU sends a processing path allocation request to the processing elements.

(4) The processing element PE1 allocates processing paths in accordance with the predetermined procedure.

It is assumed herein that the processing proceeds in the order of the general-purpose processing element PE1, the general-purpose processing element PE2, and the general-purpose processing element PE3. Then, the task starting function is called in each of the general-purpose processing elements.

(5) The client CL transmits data to the first general-purpose processing element PE1.

(6) The general-purpose processing element PE1 receives the data and calls the task execution function of the dynamic processing library DPL.

(7) The general-purpose processing element PE1 sends the result to the subsequent general-purpose processing element PE2.

(8) The general-purpose processing element PE2 receives the data and calls the task execution function of the dynamic processing library DPL.

(9) The general-purpose processing element PE2 sends the result to the subsequent general-purpose processing element PE3.

(10) The general-purpose processing element PE3 receives the data and calls the task execution function of the dynamic processing library DPL.

(11) The general-purpose processing element PE3 sends the result to the client CL.

(12) The client CL receives the result, deallocates the processing paths, and terminates the process.

Next, the function of unloading or removing the dynamic processing library DPL will be described.

A general-purpose processing element unloads or removes a dynamic processing library DPL in accordance with the following algorithm. Unloading or removal maybe requested by either one of the three sources, namely the client CL, the control unit, and the general-purpose processing element itself.

Unloading or removal may be requested by the client CL in cases where the user concludes that a dynamic processing library DPL is not necessary. Then, the user specifically designates the dynamic processing library DPL to unload or remove it.

Unloading or removal maybe requested by the control unit in cases where the control unit attempts to load a new dynamic processing library DPL into a general-purpose processing element but there is no empty slot in it. Then, the control unit requests the general-purpose processing element to unload or remove a dynamic processing library DPL not in use. The dynamic processing library DPL to be unloaded or removed is determined by the general-purpose processing element.

Unloading or removal of a dynamic processing library DPL from a general-purpose processing element is performed at a specific timing, e.g. at the time when no service is executed on the general-purpose processing element, at the time of loading, and at the time of completion of a service. At such times, a dynamic processing library DPL that was loaded previously and has not been used recently is unloaded or removed to deallocate resources.

### (Unloading Requested by Client CL)

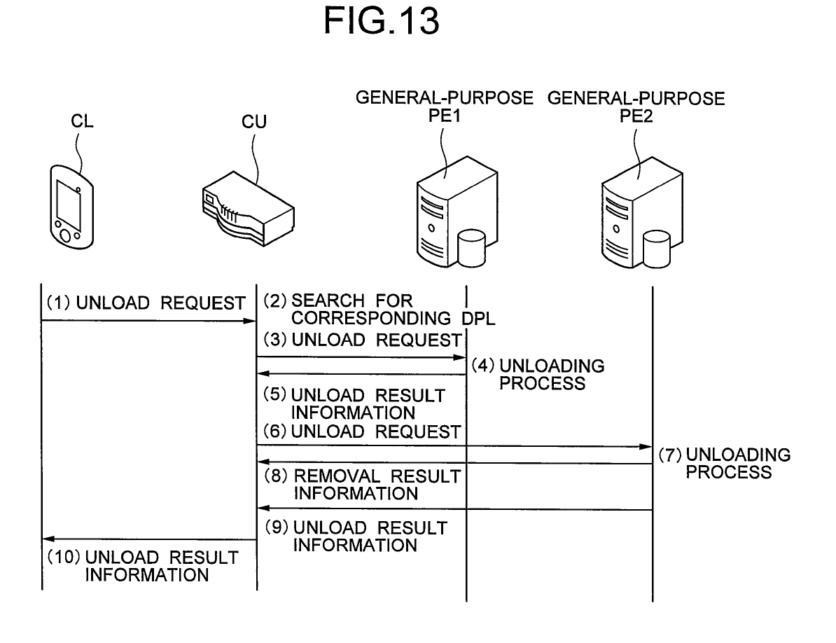

FIG. 13 shows the procedure in the case where unloading is requested by the client CL. After the end of use of a dynamic processing library DPL necessary to execute a service that was loaded into a general-purpose processing element from the client CL, the dynamic processing library DPL can be unloaded from the general-purpose processing element by a specific designation made in a request or instruction by the user, if, for example, it will not be used any longer.

(1) The client CL sends an unload request to the control unit CU. In this request, a task identifier TID is sent. The information thus sent is presented in Table 11.

TABLE 11

| Information | Description |
|---|---|
| TID | TID of DPL to be unloaded |

(2) The control unit CU searches for the dynamic processing library DPL having the corresponding task identifier TID in the general-purpose processing elements registered in it. In this case, the dynamic processing libraries DPL that have been moved to the magazine 103 are excluded from the search. If the corresponding dynamic processing library DPL is not found by the search, the unload result information is sent to the client CL at this stage.

(3) The control unit CU sends an unload request to the general-purpose processing element that has the corresponding dynamic processing library DPL.

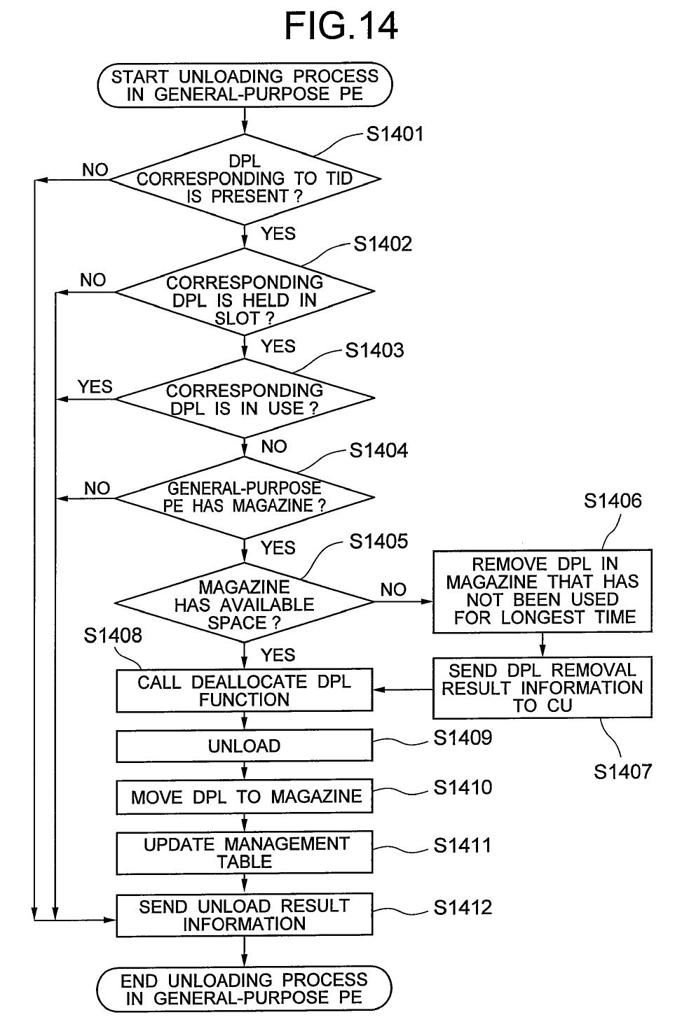

(4) The general-purpose processing element PE1 unloads the corresponding dynamic processing library DPL. The unloading process in the general-purpose processing element will be described later with reference to FIG. 14.

(5) The general-purpose processing element PE1 sends the unload result information, namely a notification of success/failure of unloading, to the control unit CU. Upon receiving the unload result information, the control unit CU updates the number of empty slots of this processing element PE.

The information that is sent to the control unit CU from the general-purpose processing element after unloading or removal is presented in Table 12

TABLE 12

| Information | Description |
|---|---|
| PEID | identifier of general-purpose PE |
| TID | task identifier of task that has been |
| | unloaded or removed from general-purpose |
| | PE |

Values that may be returned to the control unit CU from the general-purpose processing element as the unload result information are presented in Table 13. These values are commonly used in the unload result information returned from the control unit CU to the client CL.

TABLE 13

| Return Value | Description |
|---|---|
| 0 | the DPL has been unloaded |
| 1 | the corresponding DPL was not found |
| 2 | the DPL has already been unloaded (and |
| | stored in magazine) |
| 3 | the DPL has not been unloaded from some |
| | or all of general-purpose PEs because the |
| | DPL is in use or no magazine is provided |
| 4 | the DPL has been unloaded from all the |
| | general-purposes PE |

(6) If the dynamic processing library DPL is loaded in other general-purpose processing element(s), the unload request is sent to that general-purpose processing element(s). Here, it is assumed that the dynamic processing library DPL is loaded in two general-purpose processing elements.

(7) The general-purpose processing element PE2 performs the unloading process same as the above-described process.

(8) When the dynamic processing library DPL stored in the magazine 103 is removed as a consequence of unloading, the removal result information is sent to the control unit.

(9) The general-purpose processing element PE2 sends the unload result information.

(10) The control unit CU sends the unload result information to the Client CL.

FIG. 14 is a flowchart of a process of unloading a dynamic processing library DPL, executed by the general-purpose processing element.

In step S1401, upon receiving an unload request, the general-purpose processing element searches the management table for the dynamic processing library DPL corresponding to the designated task identifier TID to determine whether the corresponding dynamic processing library DPL is present or absent in it.

If it is determined in step S1401 that the corresponding dynamic processing library DPL is absent, the process proceeds to step S1412, where the unload result information, namely a notification indicating the absence of the corresponding dynamic processing library DPL, is sent to the control unit.

In step S1402, a determination is made as to whether or not the dynamic processing library DPL is held in a slot (e.g. slot 110a). If it is determined that the corresponding dynamic processing library DPL is held in a slot, a further determination is made as to whether or not the dynamic processing library DPL is in use, with reference to the number of the dynamic processing library DPL in use, in step S1403.

If it is determined in step S1402 that the corresponding dynamic processing library DPL is not held in the slot, the process proceeds to step S1412.

If it is determined that the dynamic processing library DPL is already in use, the process proceeds to step S1412. In step S1412, the unload result information, namely a notification indicating that the dynamic processing library DPL has not been unloaded from some or all of the general-purpose processing elements for the reason that the dynamic processing library DPL is in use or the magazine 103 is not provided, is sent to the control unit.

If it is determined that the dynamic processing library DPL is not in use, the process proceeds to step S1404. In step S1404, a determination is made as to whether or not the general-purpose processing element PE is provided with the magazine 103.

If it is determined that the general-purpose processing element PE is not provided with the magazine 103, the process proceeds to step S1412. In step S1412, the unload result information, namely a notification indicating that the dynamic processing library DPL has not been unloaded from some or all of the general-purpose processing elements for the reason that the dynamic processing library DPL is in use or the magazine is not provided, is sent to the control unit.

If it is determined that the magazine 103 is provided in the general-purpose processing element, the process proceeds to step S1405. In step S1405, a determination is made as to whether or not the magazine 103 has an available space.

If it is determined that the magazine 103 has an available space, the DPL deallocation function is called in step S1408.

If it is determined that the magazine 103 has no available space, one of the dynamic processing libraries DPL in the magazine is selected and removed in step S1406. The dynamic processing library DPL to be removed may be, for example, the dynamic processing library DPL that has not been used for the longest time, namely the dynamic processing library DPL having the oldest last used time.

After the dynamic processing library DPL has been removed, the removal result information is sent to the control unit CU in step S1407. Then, the process proceeds to step S1408. In step S1408, the DPL deallocation function is called.

In step S1409, the dynamic processing library DPL is unloaded.

Since a space has become available in the magazine 103, the dynamic processing library DPL is moved to the magazine 103, in step S1410.

In step S1411, the management table is updated. In step S1412, the unload result information is sent to the control unit CU.

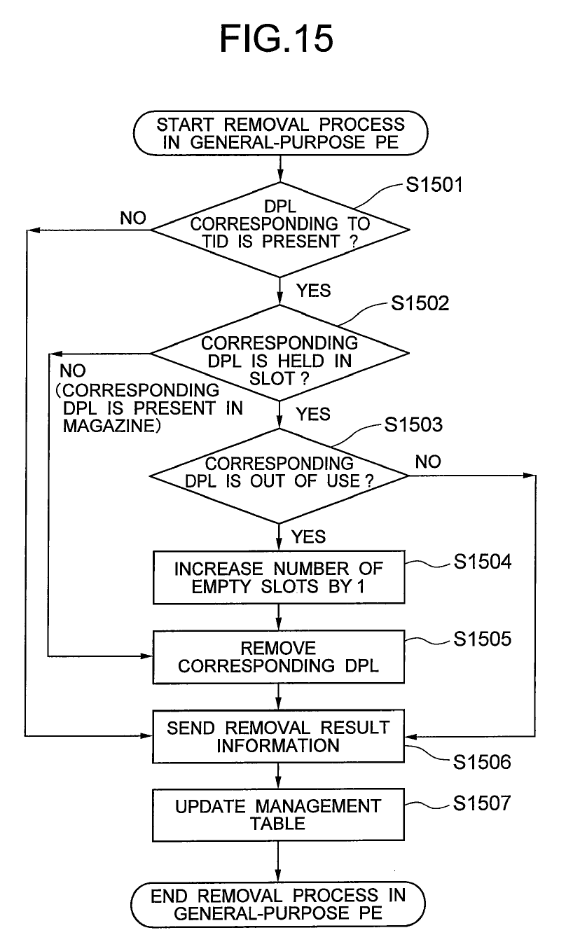

In the following, the process of removing a dynamic processing library DPL will be described with reference to FIG. 15. Here, the description will be made of a case mentioned in the above description of step S1406, that is, a case in which the dynamic processing library DPL in the magazine that has not been used for the longest time is removed. The dynamic processing library DPL to be removed is determined by the general-purpose processing element in accordance with the following procedure.

In the case where a removal request is made by the client CL, the process of removal is the same as the above-described process shown in FIG. 13 except for the replacement of “unload request” with “removal request”. In this case, the operation in the general-purpose processing element is different from the operation shown in FIG. 13.

Upon receiving the removal request, the general-purpose processing element starts the removal process. Instep S1501, the management table is searched to determine whether or not the dynamic processing library DPL corresponding to the designated task identifier TID is present.

If it is determined that the corresponding dynamic processing library DPL is not present in the management table, the process proceeds to step S1506. Instep S1506, the removal result information, or a notification indicating the absence of the corresponding dynamic processing library DPL, is sent to the control unit CU.

On the other hand, if it is determined that the corresponding dynamic processing library DPL is present in the management table, the process proceeds to step S1502. In step S1502, a determination is made as to whether or not the dynamic processing library DPL is held in the slot.

If the determination in step S1502 is negative (NO), the process proceeds to step S1505. If the determination in step S1502 is affirmative (YES), a determination is made, in step S1503, as to whether or not the slot is out of use with reference to the number of the dynamic processing library DPL in use. If it is determined that the dynamic processing library DPL is in use, the process proceeds to step S1506. In step S1506, the removal result information, namely a notification indicating that the dynamic processing library DPL has not been unloaded from some or all of the general-purpose processing elements for the reason that the dynamic processing library DPL is in use or the magazine is not provided, is sent to the control unit CU.

If the determination in step S1503 is affirmative (YES) the value of the number of empty slots is increased by 1, in step S1504. Thereafter, the process proceeds to step S1505.

If it is determined in step S1502 that the corresponding dynamic processing library DPL is not held in the slot, the process proceeds to step S1505. In step S1505, the corresponding dynamic processing library DPL stored in the magazine is removed. At this stage, it has been confirmed, by the above described search, that the dynamic processing library DPL is present in the general-purpose processing element.

After the dynamic processing library DPL has been removed, the removal result information is sent to the control unit CU in step S1506.

The removal of the dynamic processing library DPL creates an available space in the magazine 103. Therefore, a dynamic processing library DPL is moved to the magazine 103.

In step S1507, the management table is updated. Then, the unload result information is sent to the control unit CU.

When the dynamic processing library DPL is removed from the general-purpose processing element, the information presented in Tables 10 and 11 is returned to the control unit CU and the client CL as is the case with the unloading process.

Next, a description will be made of the process of unloading the dynamic processing library DPL in the case where a request for unloading is made by the control unit CU.

As a service is requested by the client CL, the control unit CU sends an unload request to a general-purpose processing element, if the following conditions A and B are met:
(A) A dynamic processing library DPL and a general-purpose processing element that can execute the dynamic processing library DPL are both available, and the service can be executed by loading the dynamic processing library DPL into the general-purpose processing element; and
(B) No general-purpose processing element has empty slot.

Then, a dynamic processing library DPL that can be unloaded from the general-purpose processing element is unloaded. Then, another dynamic processing library DPL is newly loaded into the general-purpose processing element.

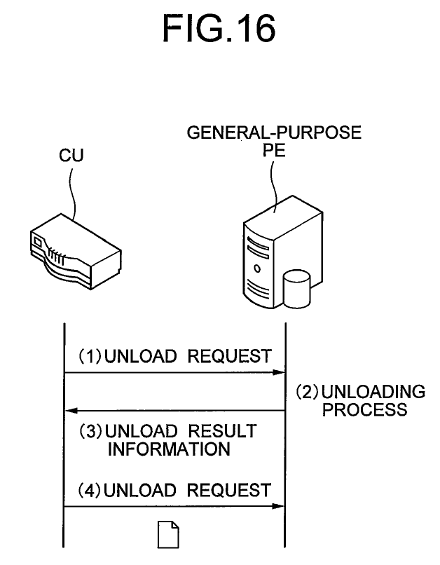

FIG. 16 shows the procedure of unloading the dynamic processing library DPL in the case where the unloading is requested by the control unit CU.

(1) The control unit CU sends an unload request to the general-purpose processing element having a slot to be made empty. What is requested by the unload request made by the control unit CU is to unload an arbitrary dynamic processing library DPL that is not in use. Therefore, the control unit CU does not send the task identifier TIC.

(2) The general-purpose processing element PE executes the above described unloading process.

(3) The general-purpose processing element PE sends the result information to the control unit CU.

(4) The control unit CU loads a new dynamic processing library DPL into the general-purpose processing element PE.

In cases where there are a plurality of relevant general-purpose processing elements, the unload request is sent to each of the general-purpose processing element until an empty slot is found.

During the above described sequence, the control unit CU may receive unload result information indicating moving of a dynamic processing library DPL from a slot to the magazine 103 or removal result information indicating deletion of a dynamic processing library DPL from the magazine.

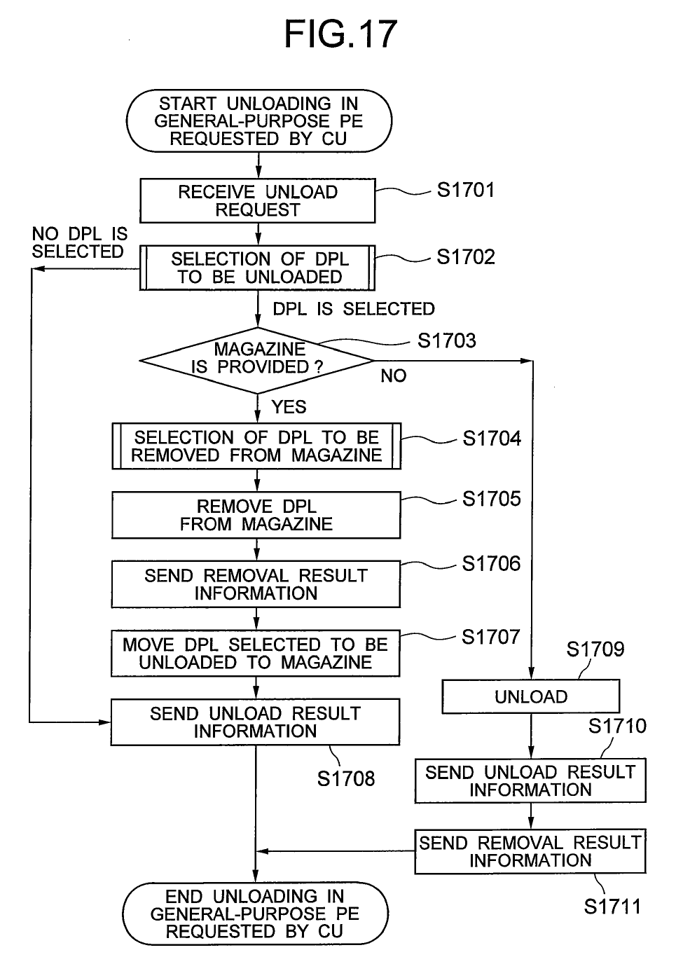

FIG. 17 is a flow chart of the process of unloading, executed by the general-purpose processing element.

Instep S1701, the general-purpose processing element PE receives an unload request from the control unit CU and starts the unloading process.

In step S1702, a dynamic processing library DPL to be unloaded is selected. The detailed procedure of this selection will be described later.

If there is no unloadable dynamic processing library DPL, the process proceeds to step S1708. In step S1708, the unload result information, namely a notification indicating that no dynamic processing library DPL is unloadable for the reason that no dynamic processing library DPL can be selected, is sent.

If there is an unloadable dynamic processing library DPL, a determination is made as to whether or not the general-purpose processing element is provided with the magazine 103, in step S1703.

If it is determined in step S1703 that the general-purpose processing element PE is not provided with the magazine 103, the destination of unloading is not exist.

Consequently, in step S1709, S1710, and S1711, a dynamic processing library DPL in the slot is unloaded, namely removed, and the unload result information and removal result information are sent.

If it is determined in step S1703 that the general-purpose processing element PE is provided with the magazine, the process proceeds to step S1704. In step S1704, a dynamic processing library DPL to be removed is selected.

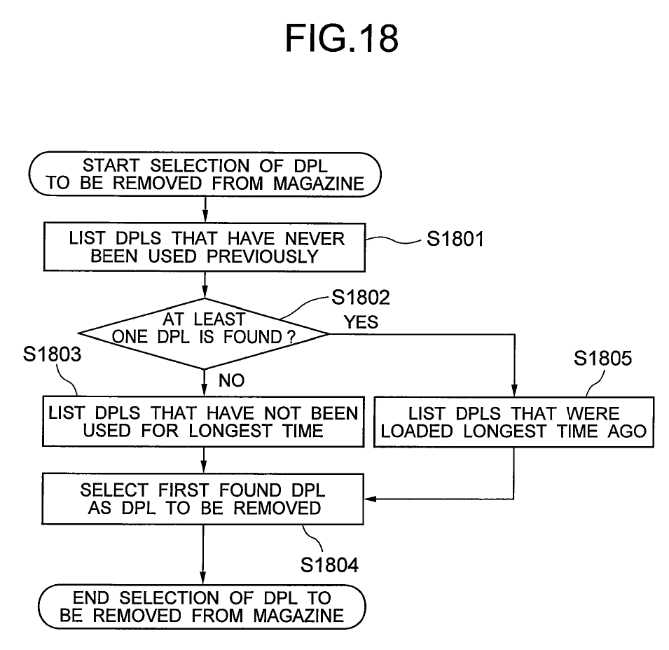

In step S1705, the dynamic processing library DPL is removed from the magazine 103. The algorithm of selecting a dynamic processing library DPL to be removed will be described later with reference to FIG. 18.

In step S1706, the removal result information is sent.

In step S1707, the selected dynamic processing library DPL is unloaded and moved to the magazine.

In step S1708, the unload result information is sent to the control unit CU.

FIG. 18 is a flow chart of the process of selecting the dynamic processing library DPL to be removed, executed by the general-purpose processing element in the case where a dynamic processing library DPL is to be removed from the magazine 103 without a designation of the task identifier TID.

In step S1801, the dynamic processing libraries DPL in the magazine 103 that has never been used in the past, e.g. the dynamic processing libraries DPL having an undefined last used time, are listed.

In step S1802, a determination is made as to whether or not a dynamic processing library DPL that meets the condition is found. If the determination in step S1802 is affirmative, the process proceeds to step S1805. Instep S1805, the dynamic processing libraries DPL that were loaded the longest time ago among the dynamic processing libraries DPL found in the above step are listed. The dynamic processing libraries DPL may be loaded at the same time. Therefore, a plurality of dynamic processing libraries DPL may be found as the dynamic processing libraries DPL that have never been used.

In step S1804, the first found dynamic processing library DPL among them is selected as the dynamic processing library DPL to be removed.

If the determination in step S1802 is negative, the process proceeds to step S1803. In step S1803, the dynamic processing libraries DPL that have not been used for the longest time are listed.

In step S1804, the first found dynamic processing library DPL among them is selected as the dynamic processing library DPL to be removed.

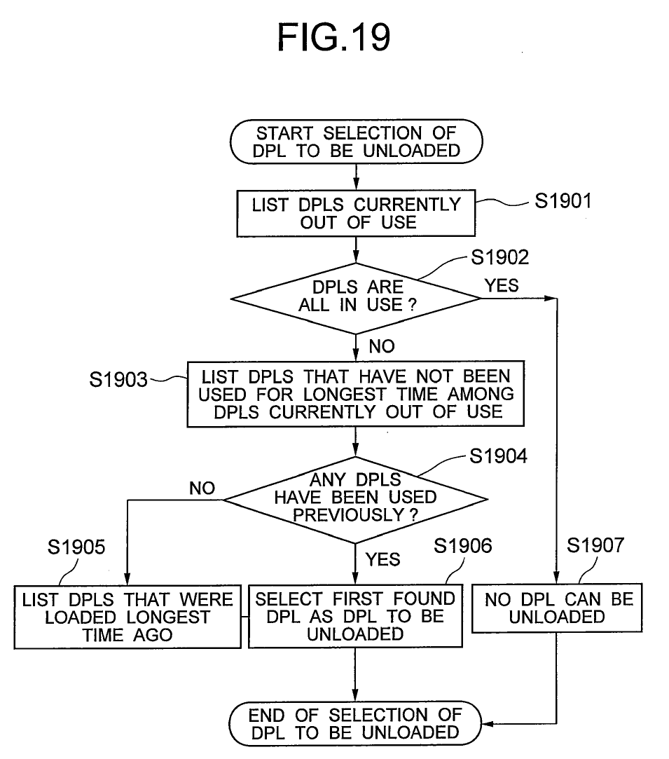

FIG. 19 is a flow chart of the process executed by the general-purpose processing element to select the dynamic processing library DPL to be unloaded from the slot (e.g. 110a) in the case where no task identifier TID is designated as described above.

In step S1901, the dynamic processing libraries DPL that are currently out of use are listed.

In step S1902, a determination is made as to whether or not all the dynamic processing libraries DPL are in use. If it is determined that all the dynamic processing libraries DPL are in use, the process proceeds to step S1907. In step S1907, a notification of the absence of the dynamic processing library DPL that can be unloaded is sent.

If the determination in step S1902 is negative, the process proceeds to step S1903. If there are dynamic processing libraries DPL currently out of use, the dynamic processing libraries DPL that have not been used for the longest time among them are listed in step S1903. The dynamic processing libraries DPL listed in this step are highly probably unnecessary.

In step S1904, a determination is made as to whether or not any of the listed dynamic processing libraries DPL have been used previously. If the determination in step S1904 is negative, the process proceeds to step S1905. In step S1905, the dynamic processing libraries DPL that were loaded the longest time ago are listed. Then, process proceeds to step S1906.

If the determination in step S1904 is affirmative, the process proceeds to step S1906. In step S1906, the first found dynamic processing library DPL, in the case where a plurality of dynamic processing libraries DPL are listed, is selected as the dynamic processing library DPL to be unloaded.

Here, the content of the sent information and the unloading process in the general-purpose processing element are the same as those in the unloading requested by the client CL.

However, the process described here is different from the process of unloading requested by the client CL in that no task identifier TID is designated and the dynamic processing library DPL to be unloaded is determined by the general-purpose processing element.

Next, a reload request from the control unit CU will be described.

The control unit CU sends a reload request when all of the following conditions (A), (B), and (C) are met:
(A) The required dynamic processing library DPL had once been loaded in the general-purpose processing element at the time of the service request from the client CL;
(B) The dynamic processing library DPL that had once been loaded has been unloaded to the magazine 103 and presently stored therein; and
(C) The service can be executed if the dynamic processing library DPL is loaded from the magazine.

The control unit CU sends a reload request to the general-purpose processing element PE, whereby the dynamic processing library DPL can be made usable again.

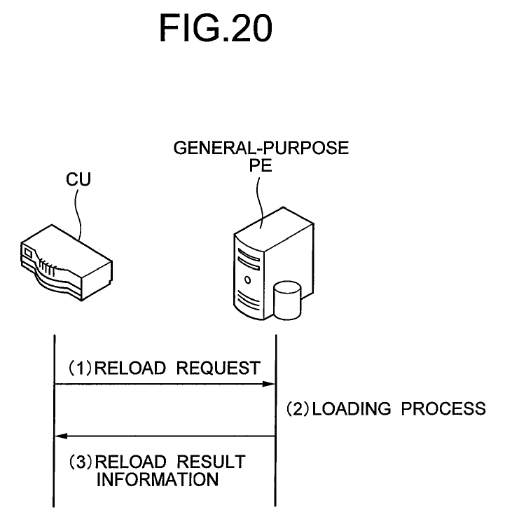

FIG. 20 shows the procedure of reloading.

(1) The control unit CU sends a reload request to the general-purpose processing element PE. The information contained in the reload request sent is presented in Table 14.

TABLE 14

| Information | Description |
|---|---|
| TID | TID of DPL to be reloaded |

(2) The general-purpose processing element PE performs the loading process.

(3) The general-purpose processing element PE sends the reload result information to the control unit CU.

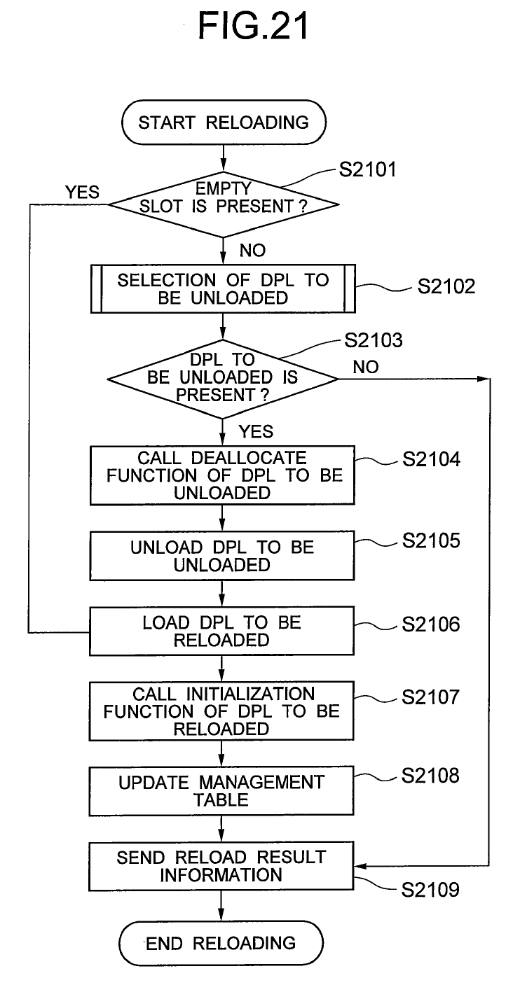

FIG. 21 is a flow chart of the process of reloading, executed by the general-purpose processing element.

In step S2101, a determination is made as to whether or not there is an empty slot. If it is determined that there is an empty slot, the process proceeds to step S2106. In step S2106, the dynamic processing library DPL is simply loaded into the empty slot.

If it is determined in step S2101 that there is no empty slot, a dynamic processing library DPL to be unloaded is selected, in step S2102.

In step S2103, a determination is made as to whether or not there is a dynamic processing library DPL that may be unloaded. If the determination in step S2103 is negative, the process proceeds to step S2109. In step S2109, the reload result information is sent.

If the determination in step S2103 is affirmative, namely if there is a dynamic processing library DPL that may be unloaded, the DPL deallocation function of the dynamic processing library DPL is called in step S2104.

In step S2105, the dynamic processing library DPL is unloaded. For example, the dynamic processing library DPL is moved to the magazine.

In step 2106, the dynamic processing library DPL to be reloaded is loaded.

In step S2107, the initialization function of the dynamic processing library DPL to be reloaded is called.

In step S2108, the DPL management table of the general-purpose processing element PE is updated.

In step S2109, the reload result information is sent to the control unit CU.

Next, a process of unloading of a dynamic processing library DPL initiated by the general-purpose processing element itself will be described.

The general-purpose processing element PE unloads a dynamic processing library DPL that has been out of use for a certain period of time to deallocate recourses, when the general-purpose processing element PE is not used presently by any client CL and has no empty slot. This quickly makes it possible to load a new dynamic processing library DPL into the general-purpose processing element PE from the control unit CU.

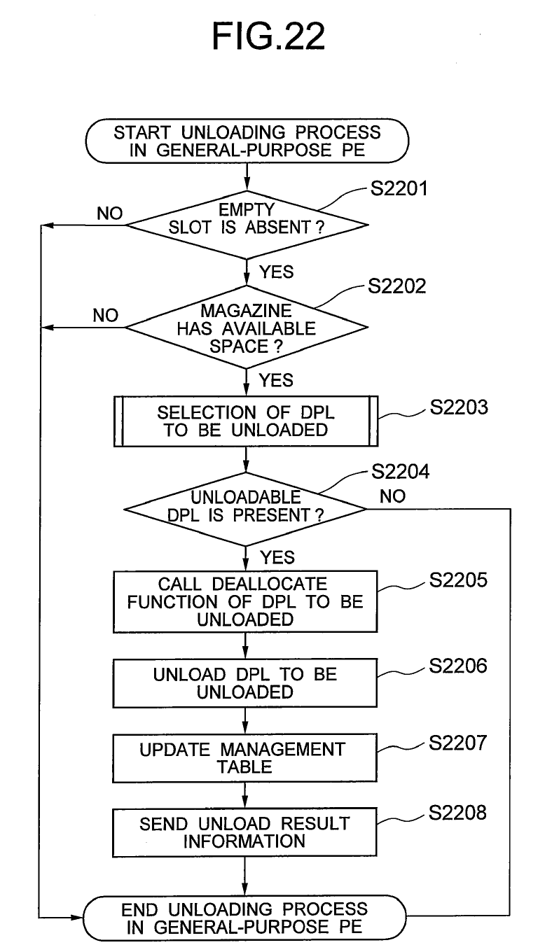

FIG. 22 is a flow chart of the process of unloading the dynamic processing library DPL initiated by the general-purpose processing element itself. For example, the process described below is executed every minute.

In step S2201, a determination is made as to whether or not there is an empty slot. In other words, the number of empty slots is checked. If the determination in step S2201 is negative, the process is terminated with no further processing.

If it is determined that there is no empty slot, a determination is made as to whether or not the magazine 103 has an available space, in step S2202. If the magazine has an available space, the process proceeds to step S2203 If the magazine has no available space, the process is terminated.

In step S2203, a dynamic processing library DPL to be unloaded is selected. The process of unloading has already been described above with reference to FIG. 19.

In step S2204, a determination is made as to whether or not there is a dynamic processing library DPL that can be unloaded. If the determination in step S2204 is negative, the process is terminated. If the determination in step S2204 is affirmative, the process proceeds to step S2205.

In step S2205, the DPL deallocation function of the dynamic processing library DPL is called.

In step S2206, the dynamic processing library DPL is unloaded.

In step S2207, the management table of the general-purpose processing element PE is updated. In step S2208, the unload result information is sent to the control unit CU.

### Embodiments

In the following, examples of service execution using a general-purpose processing element that has the following functions with the aid of the above described slot will be described:
(1) the function of loading a dynamic processing library DPL;
(2) the function of providing the task of the loaded dynamic processing library DPL, namely the function of operating as a processing element PE providing the loaded task;
(3) the function of caching the dynamic processing library DPL;
(4) the function of unloading the dynamic processing library DPL; and
(5) the function of removing the dynamic processing library DPL.

### First Embodiment

First, a description will be made of color signal conversion using a general-purpose processing element according to a first embodiment of the present invention. In the exemplary case described herein, specifically, the number of general-purpose processing elements PE is one, there is an empty slot, and loading of a dynamic processing library DPL is initiated by a request made by a client CL.

It is assumed that it is intended by a user that color signal conversion be performed by a general-purpose processing element PE. Here, the term “color signal conversion” refers to a process of converting the RGB values of an image into the YCbCr values.

In the following, an embodiment in which the color signal conversion is performed by loading a color signal conversion DPL from a client into the general-purpose processing element PE will be described.

The task identifier of the color signal conversion is defined as shown in Table 15.

TABLE 15

| TID | Task Name |
|---|---|
| 102 | color signal conversion |

The specifications of the general-purpose processing element according to this embodiment are presented in Table 16.

TABLE 16

| | |
|---|---|
| CPU | manufactured by company A |
| OS | developed by company X |
| port number | 1234 |
| number of all slots (initial | 1 (1) |
| number of empty slots) | |
| magazine | having as large an available |
| | space as the capacity of one |
| | slot |

It is assumed that the general-purpose processing element PE has already been registered in the control unit CU. It is assumed that no dynamic processing library DPL has been loaded into the general-purpose processing element PE yet and the general-purpose processing element PE has one empty slot.

It is also assumed that the dynamic processing library DPL that the client CL has can run on the CPU manufactured by company A and the OS developed by company X.

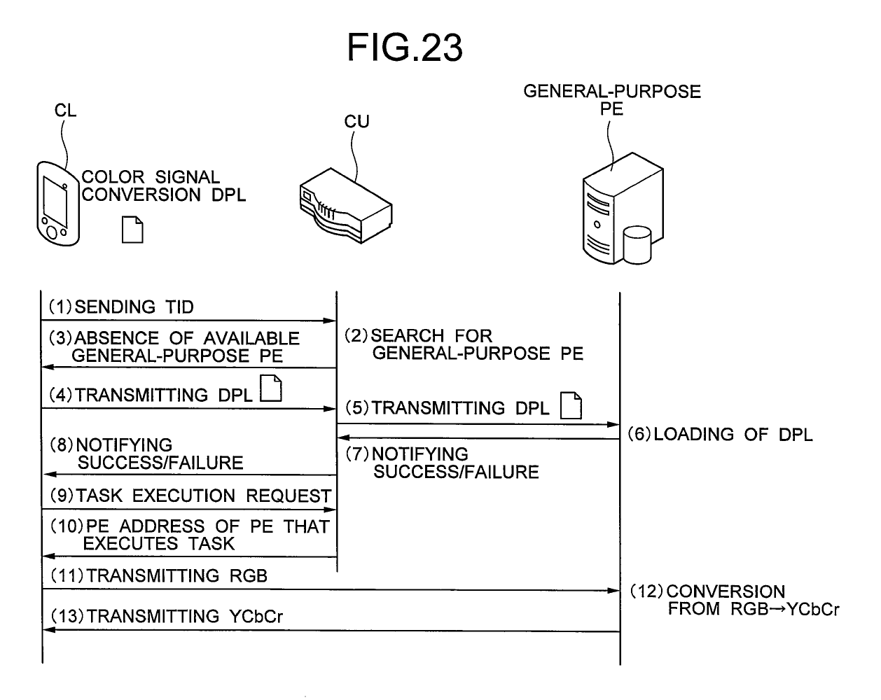

The process will be described with reference to FIG. 23.

(1) The client CL sends the task identifier TID of the task to be executed to the control unit CU.

(2) The control unit CU searches for a general-purpose processing element into which the dynamic processing library DPL for executing the task corresponding to the task identifier TID has been loaded.

(3) In this embodiment, it is assumed that no dynamic processing library DPL has been loaded. Therefore, a notification of the absence of the available general-purpose processing element is sent to the client CL.

(4) Thus, the client CL recognizes the absence of the dynamic processing library DPL that performs color signal conversion. Then, the client CL transmits the color signal conversion DPL that it has to the control unit CU.

(5) The control unit CU searches for a general-purpose processing element PE into which the dynamic processing library DPL can be loaded, and transmits the dynamic processing library DPL to the general-purpose processing element PE.

(6) The general-purpose processing element PE receives the dynamic processing library DPL, and the dynamic processing library DPL is loaded into the general-purpose processing element PE.

(7) The general-purpose processing element PE sends the load result information to the control unit CU.

(8) The control unit CU transfers the load result information received from the general-purpose processing element PE to the client CL. Here, it is assumed that the loading has been successfully done.

(9) The client CL sends a task execution request to the control unit CU.

(10) The control unit CU knows that the dynamic processing library DPL that can execute the requested task has already been loaded into the general-purpose processing element PE. Therefore, the control unit CU sends the address of the general-purpose processing element PE to the client CL.

(11) The client CL establishes connection with the general-purpose processing element PE. Then, the client CL transmits an RGB image to the general-purpose processing element PE.

(12) The general-purpose processing element PE converts the RGB image to a YCbCr image.

(13) The general-purpose processing element PE transmits the YCbCr image thus obtained to the client CL.

### Second Embodiment

Color signal conversion using a general-purpose processing element according to a second embodiment of the present invention will be described. In the exemplary case described herein, the number of general-purpose processing elements PE is one, the number of empty slots is one, and a dynamic processing library DPL is loaded from a DPL repository.

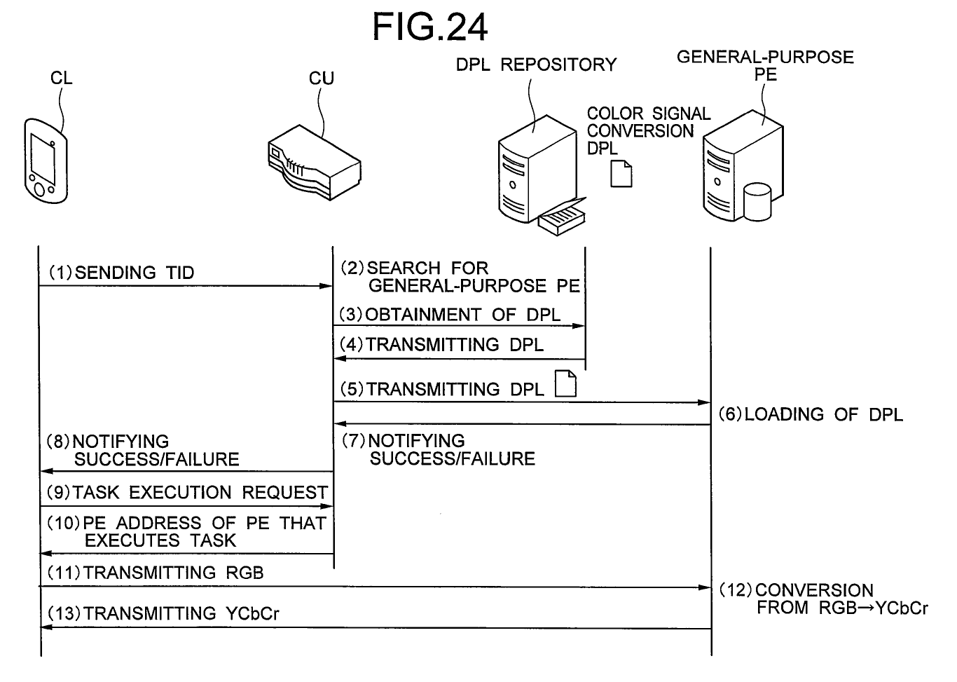

An embodiment in which a color signal conversion DPL is loaded into a general-purpose processing element from a DPL repository and executed in the general-purpose processing element PE will be described with reference to FIG. 24. Here, it is assumed that the color signal conversion DPL has already been registered in the DPL repository.

(1) The client CL sends the task identifier TID of the task to be executed to the control unit CU.

(2) The control unit CU searches for a general-purpose processing element into which the dynamic processing library DPL for executing the task corresponding to the task identifier TID has been loaded.

(3) If such a general-purpose processing element PE is not found by the search, the control unit CU sends the task identifier TID to the DPL repository, and obtains the corresponding dynamic processing library DPL.

(4) If the corresponding dynamic processing library DPL is present in the DPL repository, the dynamic processing library DPL is transmitted to the control unit CU. (5) The control unit CU searches for a general-purpose processing element PE into which the dynamic processing library

DPL can be loaded, and transmits the dynamic processing library DPL to the general-purpose processing element PE.

(6) The general-purpose processing element PE receives the dynamic processing library DPL, and the dynamic processing library DPL is loaded into the general-purpose processing element PE.

(7) The general-purpose processing element PE sends the load result information to the control unit CU.

(8) The control unit CU transfers the load result information received from the general-purpose processing element PE to the client CL. Here, it is assumed that the loading has been successfully done.

(9) The client CL sends a task execution request to the control unit CU.

(10) The control unit CU knows that the dynamic processing library DPL that can execute the requested task has already been loaded into the general-purpose processing element PE. Therefore, the control unit CU sends the address of the general-purpose processing element PE to the client CL.

(11) The client CL establishes connection with the general-purpose processing element PE and transmits an RGB image to the general-purpose processing element PE.

(12) The general-purpose processing element PE converts the RGB image to a YCbCr image.

(13) The general-purpose processing element PE transmits the YChCr image thus obtained to the client CL.

### Third Embodiment

JPEG encoding using a general-purpose processing element according to a third embodiment of the present invention will be described. In the exemplary case described herein, the number of general-purpose processing elements PE is one, and the number of empty slots is one

The JPEG encoding is performed by the following steps. It is assumed that the input image is an 8-bit RGB bitmap image.

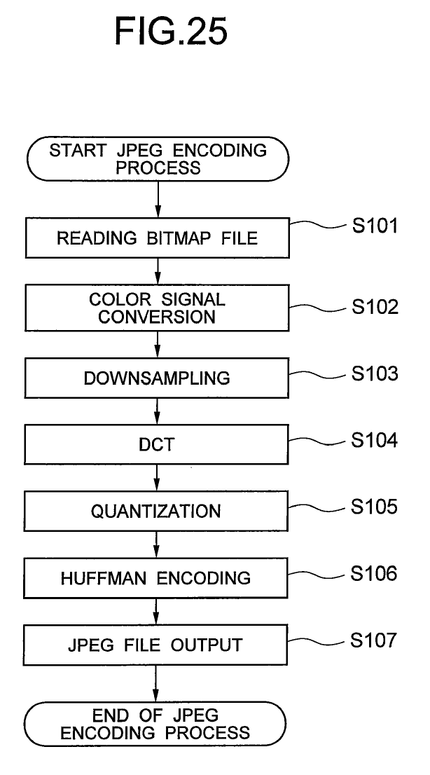

FIG. 25 is a flow chart of the JPEG encoding process according to this embodiment.

In step S101, a bitmap file is read in.

In step S102, color signal conversion is performed.

In step S103, downsampling is performed.

In step S104, discrete cosine transform (which will be sometimes referred to as DCT hereinafter) is performed.

In step S105, quantization is performed.

In step S106, Huffman encoding is performed.

In step 107, the JPEG file is output. Then, the JPEG encoding process is terminated.

Table 17 shows the correspondence between the task identifiers TID and the task names of these processes. Table 18 shows the correspondence between the service identifier SID and the service name. It is predetermined that a particular numerical value, e.g. “999”, is used as the task identifier TID for the general-purpose processing element PE.

TABLE 17

| TID | task name |
|---|---|
| 101 | reading bitmap file |
| 102 | color signal conversion |
| 103 | downsampling |
| 104 | DCT |
| 105 | quantization |
| 106 | Huffman encoding |
| 107 | JPEG file output |
| 999 | general-purpose PE |

TABLE 18

| SID | service name |
|---|---|
| 100 | JPEG encoding |

In the above mentioned embodiment, only one task is used in one processing element PE, i.e. only one processing element PE is used, and communication is performed between the client and the processing element. If the input sources and output destinations of data transfer between the tasks (i.e. the processing elements that execute the tasks) are matched in format, listing of the task identifiers TID can constitute one total process, that is a service.

The control unit holds beforehand the tasks that constitute the service. The tasks that constitute the JPEG encoding service are presented in Table 19. The data is transferred between the tasks identified by the task identifiers TID sequentially from the left to right in Table 19.

TABLE 19

| SID | TID |
|---|---|
| 100 | 101 102 103 104 105 106 107 |

Table 20 shows the task identifiers TID and the processing elements PE that provide the corresponding tasks in this embodiment.

TABLE 20

| TID | PE |
|---|---|
| 101 (reading bitmap file) | special-purpose PE1 |
| 102 (color signal conversion) | special-purpose PE2 |
| 103 (downsampling) | special-purpose PE3 |
| 104 (DCT) | none |
| 105 (quantization) | special-purpose PE4 |
| 106 (Huffman encoding) | special-purpose PE5 |
| 107 (JPEG file output) | special-purpose PE6 |
| 999 (general-purpose PE) | general-purpose PE1 with one |
| | empty slot |
| 999 (general-purpose PE) | general-purpose PE2 with one |
| | empty slot |

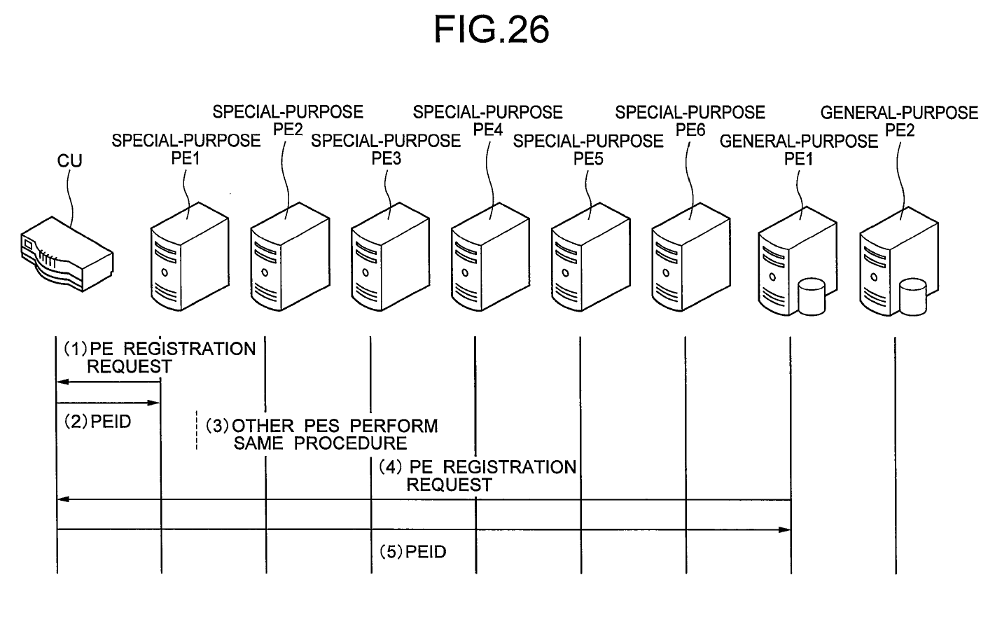

FIG. 26 shows the procedure of registering the processing elements PE in the control unit CU. Here, it is assumed that there are special-purpose processing elements PE for executing the respective tasks identified by the task identifiers TID 101 to 107 other than TID 104 in one-to-one correspondence. It is also assumed that there are two general-purpose processing elements, each of which has one empty slot.

(1) The special-purpose processing element PE1 sends a PE registration request to the control unit CU.

(2) The control unit CU registers the processing element PE to the PE management table in the control unit CU. The control unit CU issues a unique PEID, and sends it as a response to the special-purpose processing element PE1.

(3) The other special-purpose processing elements PE perform the same procedure. The order of registration of the processing elements PE may be arbitrary.

(4) The general-purpose processing element PE1 also sends a PE registration request to the control unit CU. The items of information sent at this time are the same as those in the case of the special-purpose processing element PE. Here, it is assumed that the number of empty slots of the general-purpose processing element PE1 at the time of the registration is one.

(5) The control unit CU returns a response to the general-purpose processing element PE1. Subsequently, the general-purpose processing element PE2 is registered in the same manner.

The client CL intends the JPEG encoding service to be executed. However, the registered processing elements PE do not include a processing element PE that executes the DCT associated with the task identifier TID of 104. Therefore, the service cannot be executed by them as they are.

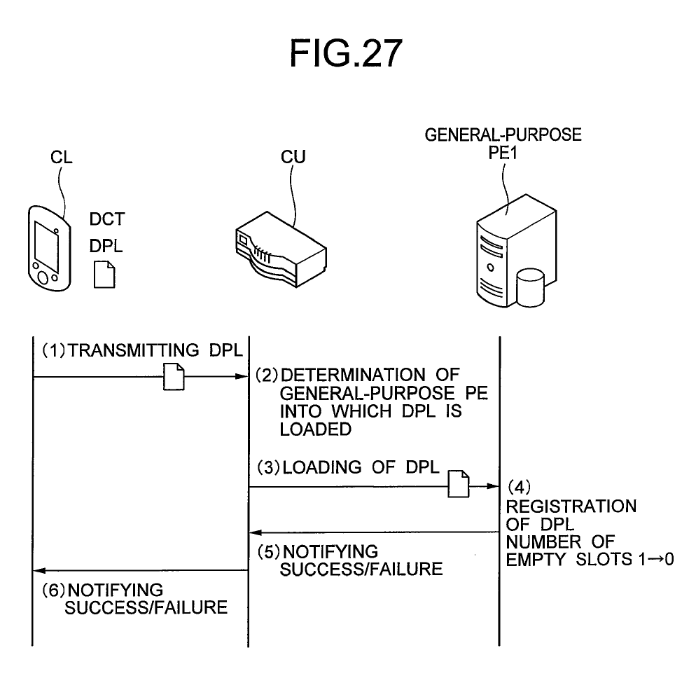

It is assumed that the client CL has the dynamic processing library DPL for DCT. The dynamic processing library DPL is loaded into a general-purpose processing element before the service request is made, in accordance with the procedure shown in FIG. 27.

(1) The client CL sends a request for loading the dynamic processing library DPL to the control unit CU.

(2) The control unit CU searches for a general-purpose processing element into which the dynamic processing library DPL can be loaded, based on the type of CPU and OS on which the dynamic processing library DPL can run. Here, it is assumed that the general-purpose processing element PE1 is found by the search.

In the case where there is a general-purpose processing element into which the dynamic processing library DPL can be loaded and the general-purpose processing element has an empty slot, the control unit CU transmits the dynamic processing library DPL to the general-purpose processing element.

(4) The general-purpose processing element PE1 checks whether the dynamic processing library DPL satisfies the requisite conditions of a dynamic processing library DPL, and loads it. Then, the value of the number of empty slots of the general-purpose processing element PE1 is decreased by 1.

If the number of empty slots becomes equal to zero, the general-purpose processing element PE1 attempts to unload one dynamic processing library DPL.

(5) The general-purpose processing element PE1 sends a notification of success of loading (if the loading of the dynamic processing library DPL has been done successfully) or a notification of failure of loading (if the loading of the dynamic processing library DPL has failed).

(6) The control unit CU transfers the success/failure notification received from the general-purpose processing element PE1 to the client CL.

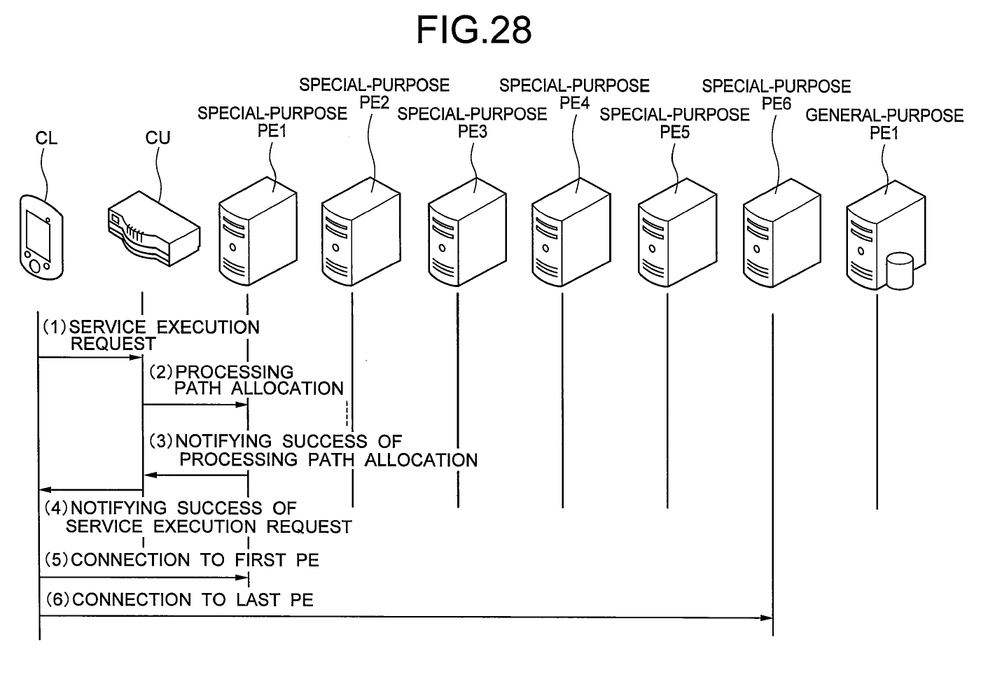

With the above described procedure, the processing elements PE for performing the JPEG encoding requested by the client CL are prepared. Subsequently, the JPEG encoding service is executed in accordance with the process shown in FIG. 28.

(1) The client CL sends a service execution request to the control unit CU.

(2) The control unit CU searches for the tasks necessary for the service and allocates processing paths. The general-purpose processing element PE1 into which the dynamic processing library DPL has been loaded is selected for the DCT processing. The detailed description of the allocation of processing paths by the control unit will be omitted because that is not the subject of the present invention.

(3) The control unit CU receives a notification of success of the processing path allocation.

(4) The control unit CU sends a notification of success of the service execution request to the client CL. At this time, the addresses of the first and last processing elements among the processing elements that provide the service are sent to the client CL.

(5) The client CL establishes connection with the first PE, i.e. the special-purpose processing element PE1.

(6) The client CL establishes connection with the last PE, i.e. the special-purpose processing element PE6.

Thus, the JPEG encoding service is ready for use, and the client CL starts to use the service. Specifically, the client CL sends a bitmap file.

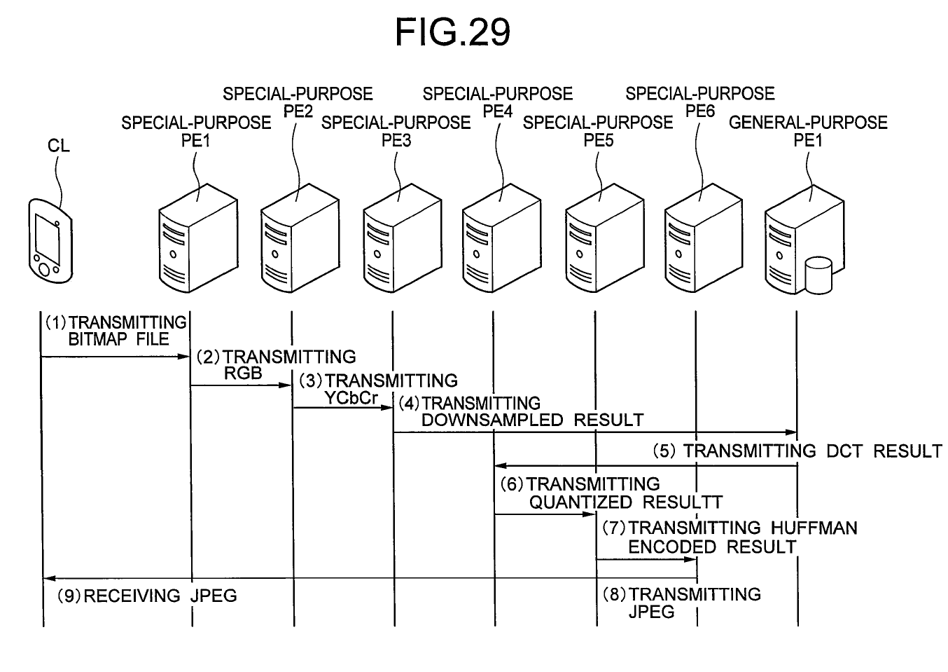

In the following, a further description will be made with reference to FIG. 29.

(1) The client CL transmits the bitmap file to the special-purpose processing element PE1.

(2) The special-purpose processing element PE1 receives the bitmap file, extracts RGB data from it, and transmits the RGB data to the special-purpose processing element PE2.

(3) The special-purpose processing element PE2 converts the RGB image data to the YCbCr image data and transmits the YCbCr image data to the special-purpose processing element PE3.

(4) The special-purpose processing element PE3 downsamples the YCbCr image data and transmits the resultant data to the general-purpose processing element PE1.

(5) Since the DCT function has been loaded into the general-purpose processing element PE1, and the function is available, the general-purpose processing element PET performs DCT on the received data and transmits the resultant data to the special-purpose processing element PE4.

(6) The special-purpose processing element PE4 performs quantization on the received data and transmits the resultant data to the special-purpose processing element PE5.

(7) The special-purpose processing element PE5 performs Huffman encoding on the received data and transmits the resultant data to the special-purpose processing element PE6.

(8) The special-purpose processing element PE6 adds a JPEG header to the received data and transmits the resultant data to the client CL.

(9) The client CL receives the JPEG data.

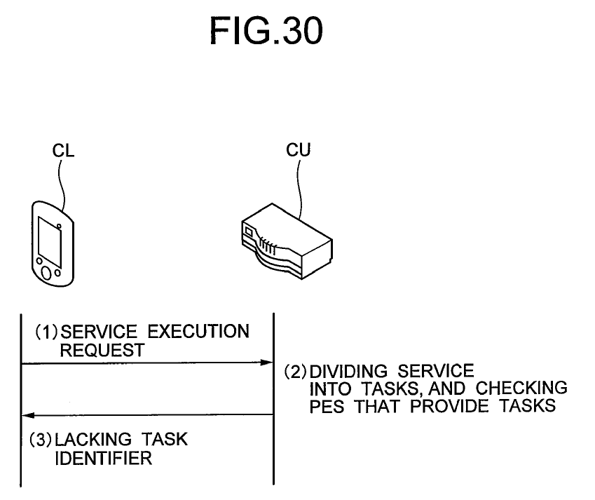

If a processing element PE that provides a task that contributes to the service is not present at the time when the service execution request is sent from the client CL to the control unit CU, the control unit CU sends the task identifier of the lacking task to the client CL (see FIG. 30).

Thus, the client CL can recognize the lacking task. Then, if the client CL has the dynamic processing library DPL that provides the lacking task, the client CL can cause it to be loaded into a general-purpose processing element.

FIG. 30 shows the process in the case where an error occurs at the time when a service execution request is made because a task(s) cannot be executed.

(1) The client CL sends a service execution request (e.g. for JPEG encoding) to the control unit CU.

(2) The control unit CU divides the service into tasks, and checks which PE can execute each of the tasks.

(3) If one or some tasks cannot be executed for the lack of processing elements PE that provide the tasks, the control unit CU sends a list of the task identifiers associated with these tasks to the client CL.

Thereafter, if the client CL has the dynamic processing library(ies) DPL for the task(s) lacking in executing the service, the client CL transmits the dynamic processing library(ies) DPL to the control unit CU. Thus, the dynamic processing library(ies) DPL can be loaded into general-purpose processing element(s) PE.

### Fourth Embodiment

JPEG encoding using a general-purpose processing element according to a fourth embodiment will be described. Described in the following is a case in which the special-purpose processing element PE goes out of order after executing the first JPEG encoding process, and in the second execution of JPEG encoding, the function having been provided by the faulty processing element PE is loaded into a general-purpose processing element PE loads.

Discussed in this embodiment is a case in which the JPEG encoding same as that described in the third embodiment is once completed and is performed again later. It is assumed that the special-purpose processing element PE2 that provides the task of color signal conversion is out of order at the time of second JPEG encoding, and the JPEG encoding cannot be performed.

A procedure followed in this case to execute the JPEG encoding by loading the dynamic processing library DPL for color signal conversion from the client CL into the general-purpose processing element PE2 will be described.

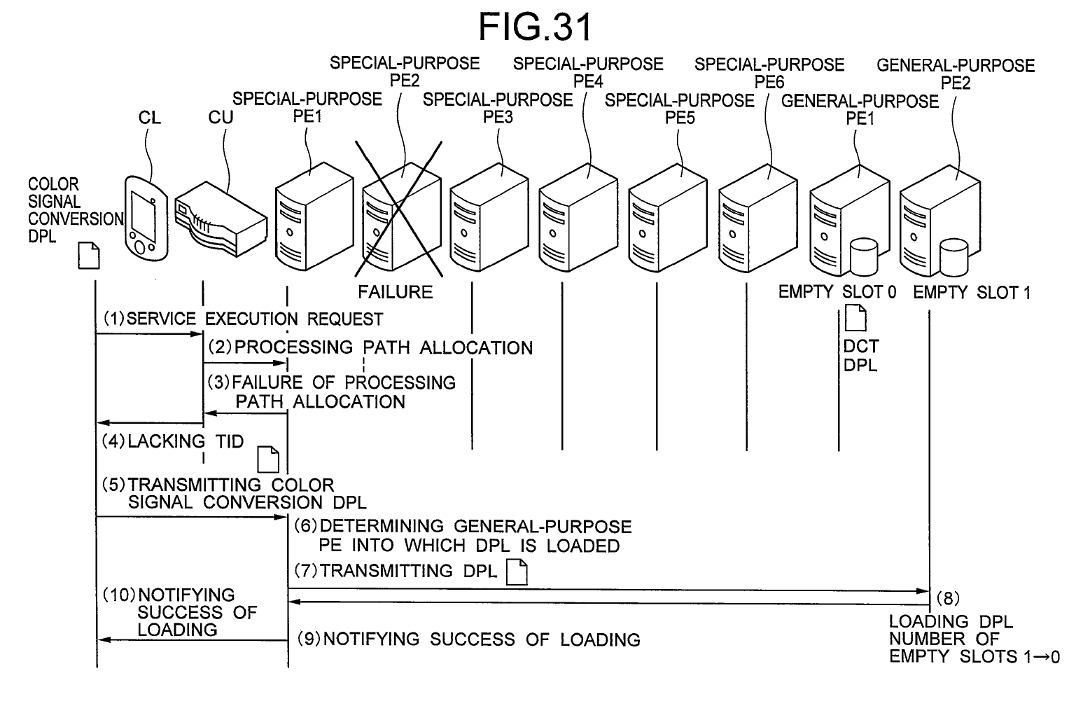

FIG. 31 shows the procedure of this case.

(1) The client CL sends a service execution request to the control unit CU.

(2) The control unit CU searches for the tasks necessary for the service and allocates processing paths. The special-purpose processing element PE2 has been registered in the control unit CU as a processing element that performs color signal conversion. At this stage, the special-purpose processing element PE2 is out of order and cannot be used. Consequently, the attempt of the control unit CU to allocate processing paths fails.

(3) The control unit CU receives a notification of failure of the processing path allocation.

(4) The control unit CU sends the task identifier TID of the color signal conversion to the client CL to specify the lacking processing element PE.

(5) The client CL recognizes that the JPEG encoding service lacks the color signal conversion task. Then, the client CL attempts to register the dynamic processing library DPL for color signal conversion that it has.

(6) The control unit CU determines the general-purpose processing element into which the dynamic processing library DPL for color signal conversion received from the client CL is to be loaded. Here, it is assumed that the general-purpose processing element PE2 having an empty slat(s) is selected.

(7) The client CL transmits the dynamic processing library DPL for color signal conversion to the general-purpose processing element PE2.

(8) The dynamic processing library DPL is loaded into the general-purpose processing element PE2.

(9) The general-purpose processing element PE2 sends a notification of success of loading of the dynamic processing library DPL, to the control unit CU.

(10) The control unit CU sends a notification of success of loading of the dynamic processing library DPL to the client CL.

By following the above-described procedure, the general-purpose processing element can be made capable of providing the color signal conversion service that has lacked in the JPEG encoding.

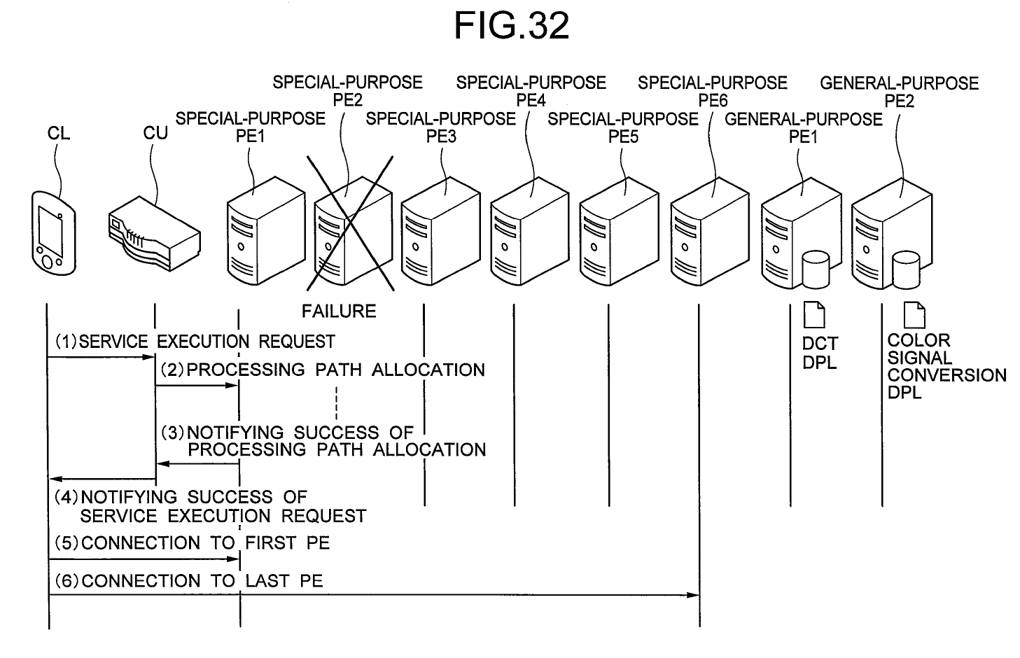

Thus, the client CL can start the service in accordance with the procedure shown in FIG. 32.

(1) The client CL sends a service execution request to the control unit CU.

(2) The control unit CU searches for the tasks necessary for the service and allocates processing paths. The general-purpose processing element PE1 into which the dynamic processing library DPL has been loaded is selected for the DOT processing. The general-purpose processing element PE2 is selected for the color signal conversion processing.

(3) The control unit CU receives a notification of success of the processing path allocation.

(4) The control unit CU sends a notification of success of the service execution request to the client CL. At this time, the addresses of the first and last processing elements PE among the processing elements that provide the service are sent to the client CL.

(5) The client CL establishes connection with the first PE, i.e. the special-purpose processing element PE1.

(6) The client CL establishes connection with the last PE, i.e. the special-purpose processing element PE6.

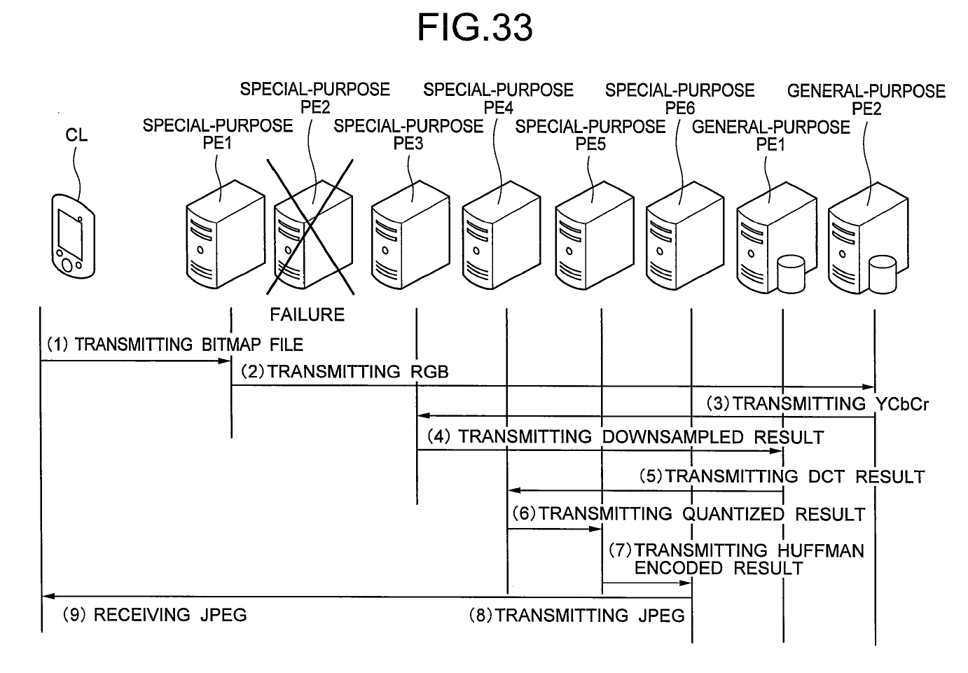

Now, the JPEG encoding service is ready for use, and the client CL can start the process as shown in FIG. 33.

(1) The client CL transmits a bitmap file to the special-purpose processing element PE1.

(2) The special-purpose processing element PE1 receives the bitmap file, and extracts RGB data from it. Then, the special-purpose processing element PE1 transmits the RGB data to the special-purpose processing element PE2.

(3) The special-purpose processing element PE2 converts the RGB data to the YCbCr data and transmits the YCbCr data to the special-purpose processing element PE3.

(4) The special-purpose processing element PE3 downsamples the YCbCr data and transmits the resultant data to the general-purpose processing element PE1.

(5) The DCT function has been loaded into the general-purpose processing element PE1. The general-purpose processing element PE1 performs DCT on the received data and transmits the resultant data to the special-purpose processing element PE4.

(6) The special-purpose processing element PE4 performs quantization on the received data and transmits the resultant data to the special-purpose processing element PE5.

(7) The special-purpose processing element PE5 performs Huffman encoding on the received data and transmits the resultant data to the special-purpose processing element PE6.

(8) The special-purpose processing element PE6 adds a JPEG header to the received data and transmits the resultant data to the client CL.

(9) The client CL receives the JPEG data.

### Fifth Embodiment

JPEG encoding using a general-purpose processing element according to a fifth embodiment of the present invention will be described. In the exemplary case described herein, the number of general-purpose processing elements PE is one, there is no empty slot, and a dynamic processing library DPL is unloaded into the magazine.

It is assumed that the number of slots of the general-purpose processing element is one, a dynamic processing library DPL other than that for DCT has already been loaded in the slot and is currently out of use, and the magazine has an available space.

This general-purpose processing element is the only one processing element that is registered in the control unit CU. Under this condition, if the client CL transmits a dynamic processing library DPL, the already existing dynamic processing library DPL in the general-purpose processing element is moved to the magazine before the dynamic processing library DPL transmitted from the client CL is loaded into the general-purpose processing element.

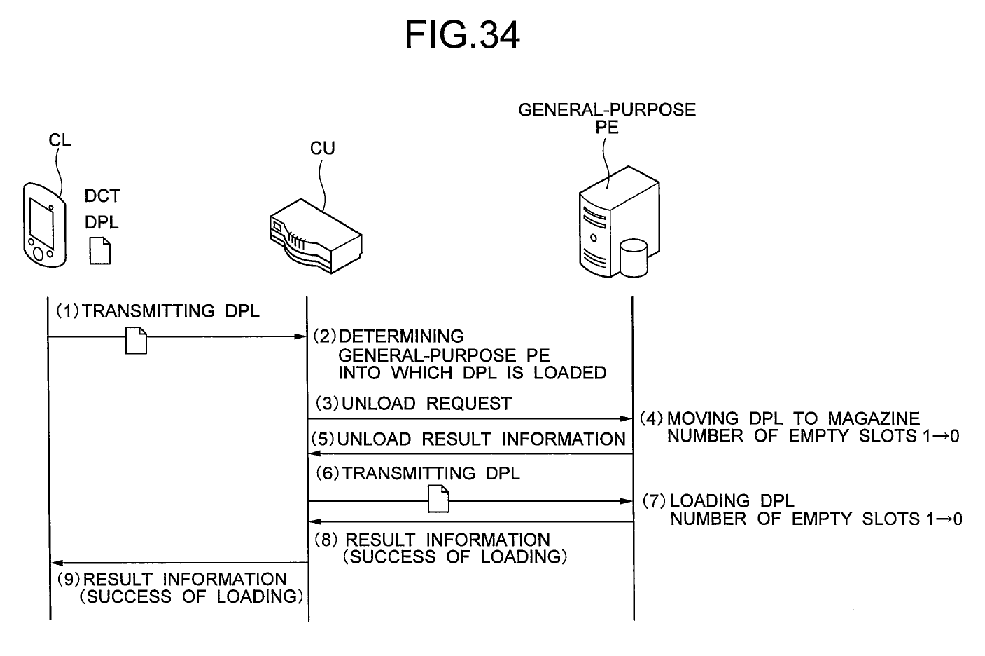

The procedure according to this embodiment will be described with reference to FIG. 34.

(1) The client CL transmits a dynamic processing library DPL to the control unit CU.

(2) The control unit CU determines the general-purpose processing element PE into which the dynamic processing library DPL is to be loaded.

(3) The general-purpose processing element PE into which the dynamic processing library DPL is to be loaded has no empty slot. Therefore, the control unit CU sends an unload request to the general-purpose processing element PE.

(4) Since there is an available space in the magazine, the general-purpose processing element PE moves the dynamic processing library DPL existing in the slot to the magazine.

(5) The general-purpose processing element PE sends the unload result information to the control unit CU.

(6) An empty slot in the general-purpose processing element being now available, the control unit CU transmits the dynamic processing library DPL to be loaded to the general-purpose processing element.

(7) The dynamic processing library DPL is loaded into the general-purpose processing element PE.

(8) The general-purpose processing element PE sends the result information to the control unit CU.

(9) The control unit CU sends the result information to the client CL.

In the case where the general-purpose processing element PE has no available magazine space and the dynamic processing library DPL is removed, a sequence similar to this embodiment is performed.

### Sixth Embodiment

JPEG encoding using a general-purpose processing element according to a sixth embodiment of the present invention will be described. In the exemplary case described herein, no empty slot is available, and there is no usable general-purpose processing element.

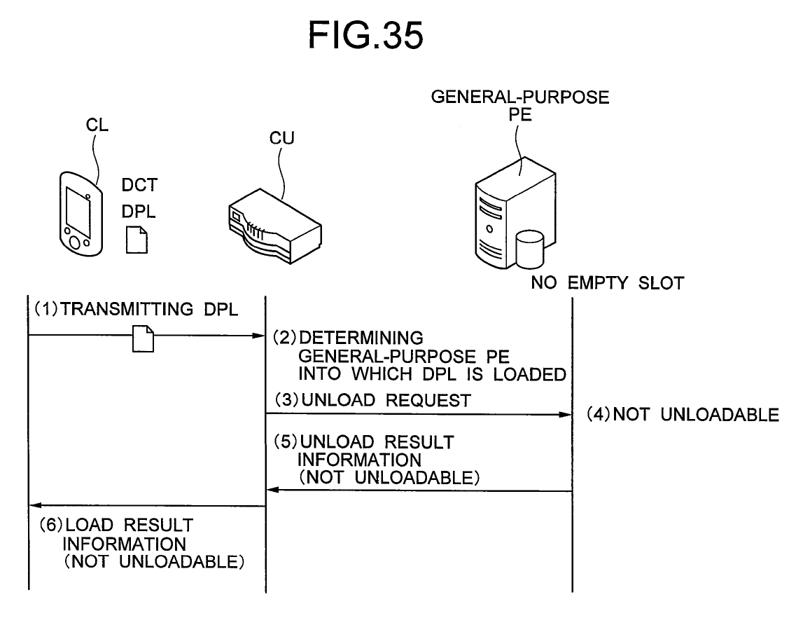

In the following, a case in which no general-purpose processing elements PE have an empty slot and a process requested by a client CL cannot be executed will be described with reference to FIG. 35.

(1) The client CL transmits a dynamic processing library DPL to the control unit CU.

(2) The control unit CU determines the general-purpose processing element PE into which the dynamic processing library DPL transmitted from the client CL can be loaded.

(3) The control unit CU sends an unload request to this general-purpose processing element PE.

(4) It is determined in the general-purpose processing element PE that there is no unloadable dynamic processing library because the dynamic processing library DPL is currently in use.

(5) The general-purpose processing element PE sends the result information indicating that the dynamic processing library DPL cannot be unloaded, to the control unit CU.

(6) If there are other general-purpose processing elements PE that have no empty slot and into which the relevant dynamic processing library DPL can be loaded, the control unit CU sends the unload request to these general-purpose processing elements PE. Here, it is assumed that no general-purpose processing element can unload a dynamic processing library.

(7) The control unit CU sends the load result information to the client CL.

In the case where there is no general-purpose processing element also, the procedure similar to this embodiment will be performed.

### Seventh Embodiment

JPEG encoding using a general-purpose processing element according to a seventh embodiment of the present invention will be described. In the exemplary case described herein, two general-purpose processing elements that operate on a single machine are used.

Here, the term “single machine” refers to an apparatus, such as a notebook computer, having a CPU on which an operation system (OS) is running. The notion “single machine” covers apparatuses in which an OS is running on another OS based on a virtualization technology.

In the exemplary case described herein, two general-purpose processing elements that operate on a single machine are used in JPEG encoding. It is assumed that the two general-purpose processing elements operating on the single machine have different port numbers. The specifications of the two general-purpose processing elements are presented in Table 21 below. It is assumed that the special-purpose processing elements PE used in this embodiment are the same as those described in the foregoing.

TABLE 21

| | general-purpose PE1 | general-purpose PE2 |
|---|---|---|
| CPU | manufactured by | manufactured by |
| | Company A | Company A |
| OS | developed by | developed by |
| | company X | company X |
| port Number | 1234 | 1235 |
| the number of all | 1 (1) | 1 (1) |
| slots (the initial | | |
| number of empty | | |
| slots) | | |
| magazine | having as large an | having as large an |
| | available space as | available space as |
| | the capacity of one | the capacity of one |
| | slot | slot |

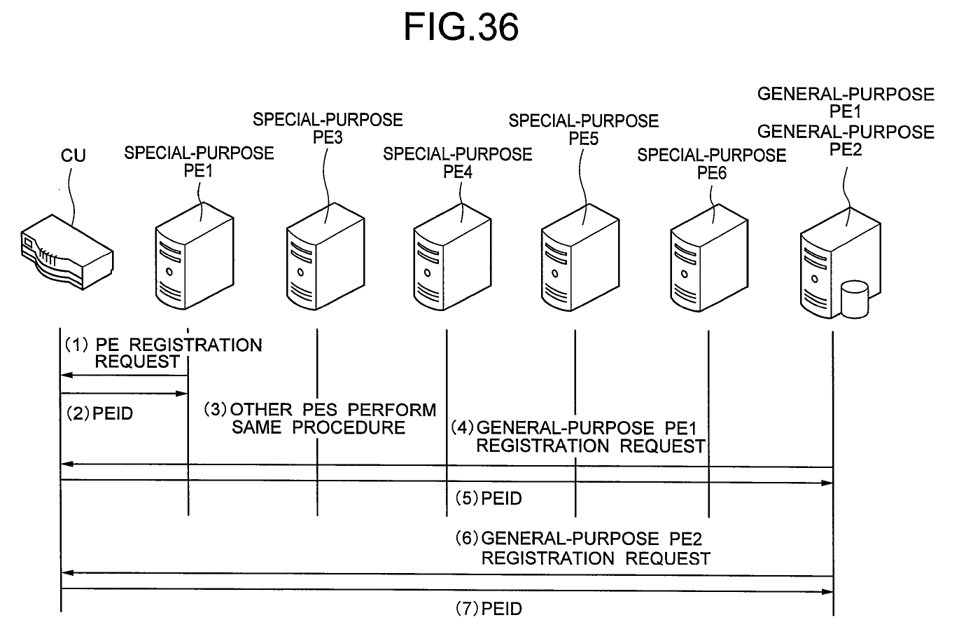

FIG. 36 shows the procedure of registering general-purpose processing elements PE1 and PE2.

(1) The special-purpose processing element PE1 sends a PE registration request to the control unit CU.

(2) The control unit CU registers the special-purpose processing element PE to the PE management table in the control unit CU. The control unit CU issues a unique PEID, and sends it as a. response to the special-purpose processing element PE1.

(3) The other special-purpose processing elements PE2 etc. perform the same procedure. The order of registration of the processing elements PE may be arbitrary.

(4) The general-purpose processing element PE1 also sends a PE registration request to the control unit CU. The items of information sent at this time are the same as those in the case of the special-purpose processing element PC. Here, it is assumed that the number of empty slots of the general-purpose processing element PE1 at the time of the registration is one.

(5) The control unit CU returns a response to the general-purpose processing element PE1.

(6) The general-purpose processing element PE2 also sends a PE registration request to the control unit CU. It is assumed that the number of empty slots of the general-purpose processing element PE2 at the time of the registration is one. The control unit CU distinguishes the general-purpose processing element PE1 and the general-purpose processing element PE2 from each other by the difference in their port numbers. The port number of the general-purpose processing element PE1 is 1234, and the port number of the general-purpose processing element PE2 is 1235.

(7) The control unit CU returns a response to the general-purpose processing element PE2.

Then, the dynamic processing libraries DPL for color signal conversion and DCT lacking in executing JPEG encoding are loaded into the general-purpose processing elements from the client CL. Since the process of loading the dynamic processing libraries DPL into the general-purpose processing element is the same as the above described sequence, a description thereof will be omitted.

It is assumed that the dynamic processing library DPL for color signal conversion is loaded into the general-purpose processing element PE1 and the dynamic processing library DPL for DCT is loaded into the general-purpose processing element PE2.

With the above described procedure, the JEG encoding is ready for execution. Then, the client CL sends a service execution request to the control unit CU, which is the same sequence as described above and a description thereof will be omitted.

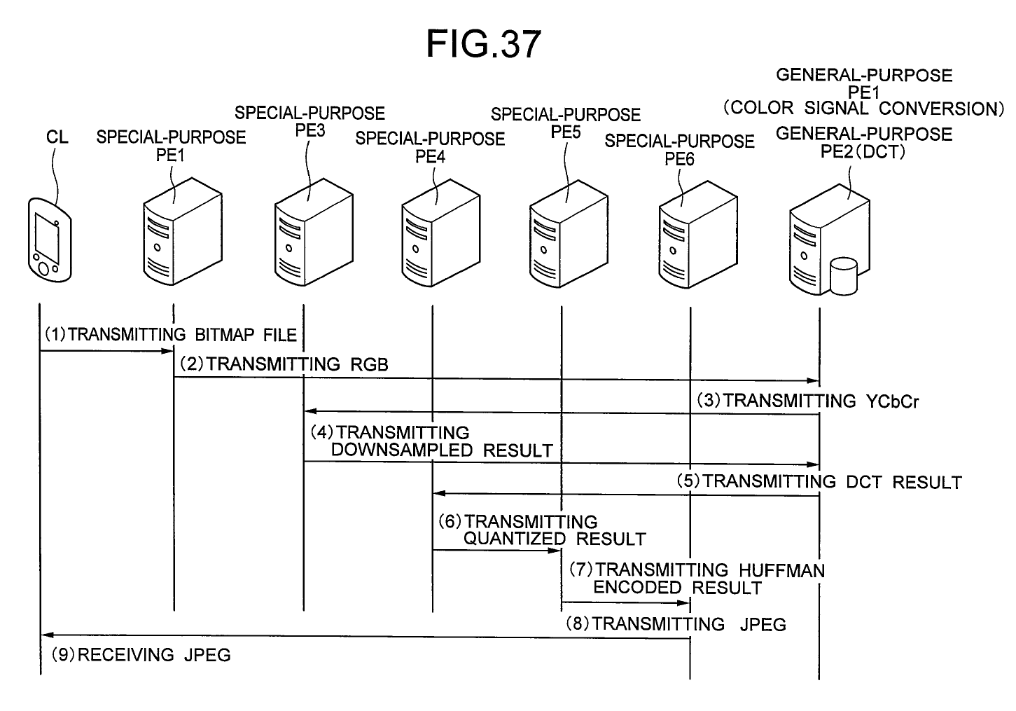

FIG. 37 shows a flow of data in the JPEG encoding.

(1) The client CL transmits a bitmap file to the special-purpose processing element PE1.

(2) The special-purpose processing element PE1 receives the bitmap file, extracts RGB data from it, and transmits the RGB data to the general-purpose processing element PE1.

(3) The general-purpose processing element PE1 converts the RGB data to the YCbCr data and transmits the YCbCr data to the special-purpose processing element PE3.

(4) The special-purpose processing element PE3 downsamples the YCbCr data and transmits the resultant data to the general-purpose processing element PE2.

(5) The DOT function has been loaded into the general-purpose processing element PE2. The general-purpose processing element PE2 performs DCT on the received data and transmits the resultant data to the special-purpose processing element PE4.

(6) The special-purpose processing element PE4 performs quantization on the received data and transmits the resultant data to the special-purpose processing element PE5.

(7) The special-purpose processing element PE5 performs Huffman encoding on the received data and transmits the resultant data to the special-purpose processing element PE6.

(8) The special-purpose processing element PE6 adds a JPEG header to the received data and transmits the resultant data to the client CL.

(9) The client CL receives the JPEG data.

Although TCP/IP communication is used in the above described embodiments, UDP communication may be used. Any communication scheme, whether wired or wireless, may be used without limitation as long as the above-described communication processes can be implemented.

The data structures used in the above-described embodiments are not limiting. Any data structure may be used as long as the above-described operations can be achieved.

The information managed by the control unit CU and the general-purpose processing elements described in the above description of the embodiments is only minimum information necessary for the operations. The information managed by the control unit CU and the general-purpose processing elements is not limited to that described in the foregoing but may include other information as long as the operations described in the foregoing can be achieved.

In the above description of the embodiments, JPEG encoding has been discussed by way of example. However, the invention may be applied to other processings such as MPEG encoding etc.

The present invention can suitably be applied to a general-purpose processing element into which a program can be installed on an on-demand basis and that can executes the program.

The present invention is advantageous in that a general purpose processing element(s) existing on a network can execute an arbitrary desired processing in accordance with a request from a client.

What is claimed:

1. A general-purpose processing element comprising a program holding portion that can hold a program by which a specific function is implemented in the general-purpose processing element.

2. The processing element according to claim 1, wherein the program holding portion comprises one or more slots in each of which a program is held.

3. The processing element according to claim 2, wherein the number of the slots is predetermined and more than one.

4. The processing element according to claim 2, wherein the number of the slots is not predetermined and is more than one.

5. The processing element according to claim 1 further comprising a storing portion in which the held program is to be saved.

6. The processing element according to claim 1 further comprising a magazine portion into which the program is unloaded and in which the program is held.

7. The processing element according to claim 1, wherein the processing element has a function of executing the program at appropriate timing.

8. A distributed processing system comprising:
a control unit;
a plurality of processing elements connected to the control unit; and
a client, wherein
the plurality of processing elements include the processing element according to claim 1.

9. The distributed processing system according to claim 8, wherein the client transmits a signal for unloading the program held in the processing element.

10. The distributed processing system according to claim 8, wherein the control unit transmits a signal for unloading the program held in the processing element.

11. The distributed processing system according to claim 8, wherein the processing element transmits a signal for unloading the program held in the processing element.

12. A processing element comprising:
a single machine; and
a plurality of general-purpose processing elements operating on the signal machine, wherein
the general-purpose processing elements include the general-purpose processing element according to claim 1.
